(19) United States
(12) Patent Application Publication
(10) Pub. No.: US 2016/0151972 A1
(43) Pub. Date: Jun. 2, 2016

(54) THREE-DIMENSIONAL OBJECT FORMATION APPARATUS, CONTROL METHOD OF THREE-DIMENSIONAL OBJECT FORMATION APPARATUS, AND CONTROL PROGRAM OF THREE-DIMENSIONAL OBJECT FORMATION APPARATUS

(71) Applicant: SEIKO EPSON CORPORATION, Tokyo (JP)

(72) Inventor: Kohei UTSUNOMIYA, Matsumoto (JP)

(21) Appl. No.: 14/855,607

(22) Filed: Sep. 16, 2015

(30) Foreign Application Priority Data
Nov. 28, 2014 (JP) 2014-240714

(51) Int. Cl. B29C 67/00

(52) U.S. Cl. CPC B29C 67/0059; B29C 67/0088; B29K 2995/0021; B33Y 10/00

(57) ABSTRACT

Provided is a three-dimensional object formation apparatus including: a head unit which discharges a plurality of types of liquid including first liquid and second liquid, and forms dots with the discharged liquid; a curing unit which cures the dots; and a control unit which controls the head unit so as to form the support and form the three-dimensional object by laminating layered formation bodies formed with the cured dots, in which the control unit controls a plurality of control modes including a first control mode of controlling the head unit so that the first liquid is discharged from the head unit in order to form one dot, and a second control mode of controlling the head unit so that the second liquid is discharged from the head unit in order to form the one dot, when the designation data designates the second liquid as liquid for forming the one dot.

This application claims priority to Japanese Patent Application No. 2014-240714 filed on Nov. 28, 2014. The entire disclosure of Japanese Patent Application No. 2014-240714 is hereby incorporated herein by reference.

### BACKGROUND

1. Technical Field

The present invention relates to a three-dimensional object formation apparatus, a control method of a three-dimensional object formation apparatus, and a control program of a three-dimensional object formation apparatus.

2. Related Art

In recent years, various three-dimensional object formation apparatuses such as a 3D printer have been proposed. The three-dimensional object formation apparatus executes a formation process of curing dots which are formed by discharging liquid such as ink, forming a formation body having a predetermined thickness with the cured dots, and laminates the formed formation bodies to form a three-dimensional object.

In such a three-dimensional object formation apparatus, a three-dimensional object having a so-called overhang shape which is a projected shape with an inclination angle which is larger than 90 degrees, may be formed, for example. In this case, even when it is attempted to form a three-dimensional object by simply laminating formation bodies, the portion in the overhang shape (hereinafter, referred to as an “overhung portion”) among the three-dimensional objects may fall and it is difficult to form a three-dimensional object in a desirable shape. Accordingly, regarding the three-dimensional object having the overhung portion, a technology of forming a support which supports the overhung portion and forming a three-dimensional object in a proper shape while preventing the falling of the overhung portion has been proposed (for example, see JP-A-2000-280354 and JP-A-2011-245823).

However, the formation process may be stopped due to insufficient liquid for forming the support during the execution of the formation process. Regarding the three-dimensional object formed through stopping and restarting of the operation, a possibility of generation of variations in a degree of curing of dots configuring the three-dimensional object is increased due to a factor of generation of variation in curing time for curing the liquid due to the stopping, compared to a three-dimensional object which is formed in a formation process without stopping. In this case, color unevenness, concavities and convexities, or a decrease in strength may be generated on the formed three-dimensional object and a possibility of a decrease in quality of the three-dimensional object may be increased.

### SUMMARY

An advantage of some aspects of the invention is to provide a technology of decreasing a possibility of stopping a formation process caused by insufficient liquid used in the formation of a support which supports a three-dimensional object, during execution of the formation process of forming the three-dimensional object by a three-dimensional object formation apparatus.

According to an aspect of the invention, there is provided a three-dimensional object formation apparatus including: a head unit which discharges a plurality of types of liquid including first liquid for forming a support which supports a three-dimensional object and second liquid for forming the three-dimensional object, when forming the three-dimensional object, and forms dots with the discharged liquid; a curing unit which cures the dots; and a control unit which controls the head unit so as to form the support and form the three-dimensional object by laminating layered formation bodies formed with the cured dots, in which the control unit controls a plurality of control modes including a first control mode of controlling the head unit so that the first liquid is discharged from the head unit in order to form one dot, when designation data for designating the type of liquid for forming the dot designates the first liquid as liquid for forming the one dot configuring the support, and a second control mode of controlling the head unit so that the second liquid is discharged from the head unit in order to the form one dot, when the designation data designates the second liquid as liquid for forming the one dot.

The three-dimensional object formation apparatus according to the aspect of the invention can form one dot with the first liquid or the second liquid which is a type different from that of the first liquid, when the one dot configuring the support for supporting the three-dimensional object is designated to be formed with the first liquid by the designation data. That is, in this case, the support can be formed with the first liquid and the second liquid. Accordingly, it is possible to decrease a possibility of stopping of the formation process due to lack of the first liquid, compared to a case of forming the dot configuring the support with only the first liquid according to the designation of the designation data. Therefore, it is possible to prevent a decrease in quality of the three-dimensional object due to the stopping of the formation process.

According to another aspect of the invention, there is provided a three-dimensional object formation apparatus including: a head unit which discharges a plurality of types of liquid including first liquid for forming a support which supports a three-dimensional object and second liquid for forming the three-dimensional object, when forming the three-dimensional object, and forms dots with the discharged liquid; a curing unit which cures the dots; a control unit which controls the head unit so as to form the support and form the three-dimensional object by laminating layered formation bodies formed with the cured dots; a storage unit which stores the first liquid; and an output unit which outputs residual amount information showing a residual amount of the first liquid stored in the storage unit, in which the control unit controls a plurality of control modes including a first control mode of controlling the head unit so as to form the support with a plurality of dots formed of the first liquid, and a second control mode of controlling the head unit so as to form the support with a plurality of dots not including the dots formed of the first liquid and including the dots formed of the second liquid, and the control mode is switched from the first control mode to the second control mode, when a residual amount of the first liquid shown by the residual amount information is changed from an amount greater than a first reference amount to an amount equal to or smaller than the first reference amount, when forming the three-dimensional object.

In this case, the support is formed with the second liquid, when the residual amount of the first liquid is changed to an amount equal to or smaller than the first reference amount and the first liquid may be insufficient during the execution of the formation process. Therefore, it is possible to decrease a possibility of stopping of the formation process due to lack of the liquid to be used in the formation of the support. The first reference amount may be an amount equal to or greater than “0”.

According to still another aspect of the invention, there is provided a three-dimensional object formation apparatus including: a head unit which discharges a plurality of types of liquid including first liquid for forming a support which supports a three-dimensional object and second liquid for forming the three-dimensional object, when forming the three-dimensional object, and forms dots with the discharged liquid; a curing unit which cures the dots; a control unit which controls the head unit so as to form the support and form the three-dimensional object by laminating layered formation bodies formed with the cured dots; a storage unit which stores the first liquid; and an output unit which outputs residual amount information showing a residual amount of the first liquid stored in the storage unit, in which the control unit controls a plurality of control modes including a first control mode of controlling the head unit so as to form the support with a plurality of dots formed of the first liquid, and a third control mode of controlling the head unit so as to form the support with a plurality of dots including the dots formed of the first liquid and the dots formed of the second liquid, and the control mode is switched from the first control mode to the third control mode, when a residual amount of the first liquid shown by the residual amount information is changed from an amount greater than a second reference amount to an amount equal to or smaller than the second reference amount, when forming the three-dimensional object.

In this case, the support is formed using both of the first liquid and the second liquid, when the residual amount of the first liquid is changed to an amount equal to or smaller than the second reference amount and the residual amount of the first liquid is not sufficient. Therefore, it is possible to decrease a possibility of stopping of the formation process due to lack of the liquid to be used in the formation of the support. The second reference amount may be an amount greater than “0”.

In the three-dimensional object formation apparatus described above, the control unit may control the head unit so as to form a connection area of the support including a portion coming into contact with the three-dimensional object with a plurality of dots formed of the first liquid, in the third control mode.

In this case, the connection area of the support is formed with the first liquid. That is, the liquid for forming the three-dimensional object and the liquid for forming the connection area of the support are different from each other. Therefore, it is easy to separate the support from the three-dimensional object after forming the three-dimensional object, compared to a case where the liquid for forming the three-dimensional object and the liquid for forming the connection area of the support are the same.

In the three-dimensional object formation apparatus described above, it is preferable that the second liquid is liquid of which a weight ratio of a color material component included in the second liquid is equal to or smaller than a predetermined value.

In this case, the support is formed using the second liquid having a small content of the color material component and high transparency, when there is no sufficient residual amount of the first liquid for forming the support. Therefore, when executing the coloring on the outer surface of the three-dimensional object, it is possible to properly display the color of the three-dimensional object, even when color of the liquid for forming the support is attached to the three-dimensional object.

According to still another aspect of the invention, there is provided a control method of a three-dimensional object formation apparatus which includes a head unit which discharges a plurality of types of liquid including first liquid for forming a support which supports a three-dimensional object and second liquid for forming the three-dimensional object, when forming the three-dimensional object, and forms dots with the discharged liquid, and a curing unit which cures the dots, and forms the support and forms the three-dimensional object by laminating layered formation bodies formed with the cured dots, the method including: controlling the head unit so that the support is formed in a plurality of control modes including a first control mode of discharging the first liquid from the head unit in order to form one dot, when designation data for designating the type of liquid for forming the dot designates the first liquid as liquid for forming the one dot configuring the support, and a second control mode of discharging the second liquid from the head unit in order to form the one dot, when the designation data designates the second liquid as liquid for forming the one dot.

In this case, the dot configuring the support can be formed with the first liquid or the second liquid. Accordingly, it is possible to decrease a possibility of stopping of the formation process due to lack of the first liquid, compared to a case where the dot configuring the support can be formed with only the first liquid. Therefore, it is possible to prevent a decrease in quality of the three-dimensional object due to the stopping of the formation process.

According to still another aspect of the invention, there is provided a control program of a three-dimensional object formation apparatus which includes a head unit which discharges a plurality of types of liquid including first liquid for forming a support which supports a three-dimensional object and second liquid for forming the three-dimensional object, when forming the three-dimensional object, and forms dots with the discharged liquid, a curing unit which cures the dots, and a computer, and forms the support and forms the three-dimensional object by laminating layered formation bodies formed with the cured dots, the program causing the computer to function as: a control unit which controls the head unit so that the support is formed in a plurality of control modes including a first control mode of controlling the head unit so that the first liquid is discharged from the head unit in order to form one dot, when designation data for designating the type of liquid for forming the dot designates the first liquid as liquid for forming the one dot configuring the support, and a second control mode of controlling the head unit so that the second liquid is discharged from the head unit in order to form the one dot, when the designation data designates the second liquid as liquid for forming the one dot.

In this case, the dot configuring the support can be formed with the first liquid or the second liquid. Accordingly, it is possible to decrease a possibility of stopping of the formation process due to lack of the first liquid, compared to a case where the dot configuring the support can be formed with only the first liquid. Therefore, it is possible to prevent a decrease in quality of the three-dimensional object due to the stopping of the formation process.

### BRIEF DESCRIPTION OF THE DRAWINGS

The invention will be described with reference to the accompanying drawings, wherein like numbers reference like elements.

FIG. 1 is a block diagram showing a configuration of a three-dimensional object formation system according to the invention.

FIGS. 2A to 2E are explanatory diagrams for illustrating the formation of an object by the three-dimensional object formation system.

FIG. 3 is a schematic sectional view of a three-dimensional object formation apparatus.

FIG. 4 is a schematic sectional view of a recording head.

FIGS. 5A to 5C are explanatory diagrams for illustrating an operation of a discharging unit when supplying a driving signal.

FIG. 6 is a plan view showing an arrangement example of nozzles of the recording head.

FIG. 7 is a block diagram showing a configuration of a driving signal generation unit.

FIG. 8 is an explanatory diagram showing the content of a selection signal.

FIG. 9 is a timing chart showing waveforms of a driving waveform signal.

FIG. 10 is a flowchart showing a data generation process and a formation process.

FIGS. 11A to 11C are explanatory diagrams for illustrating a three-dimensional object and a support.

FIG. 12 is a flowchart showing an inner shape complementation process.

FIG. 13 is a flowchart showing a support shape complementation process.

FIG. 14 is an explanatory diagram for illustrating a control mode.

FIG. 15 is an explanatory diagram for illustrating a support according to Modification Example 2.

FIG. 16 is an explanatory diagram for illustrating a control mode according to Modification Example 3.

FIG. 17 is a flowchart showing a data generation process and a formation process according to Modification Example 6.

FIGS. 18A to 18F are explanatory diagrams for illustrating the formation of a three-dimensional object performed by a three-dimensional object formation system according to Modification Example 6.

### DESCRIPTION OF EXEMPLARY EMBODIMENTS

Hereinafter, embodiments for realizing the invention will be described with reference to the drawings. Herein, in each drawing, dimensions and scales of each drawing are appropriately modified from the actual dimensions and scales. The embodiments which will be described below are preferable specific examples of the invention, and therefore, various technologically preferable limitations are set. However, the scope of the invention is not limited to the embodiments, unless there is a limitation of the invention in the following description.

### A. Embodiment

In the embodiment, as a three-dimensional object formation apparatus, an ink jet type three-dimensional object formation apparatus which discharges a curable ink (an example of “liquid”) such as resin ink containing a resin emulsion or ultraviolet curable ink to form a three-dimensional object Obj will be described as an example.

### 1. Configuration of Three-Dimensional Object Formation System

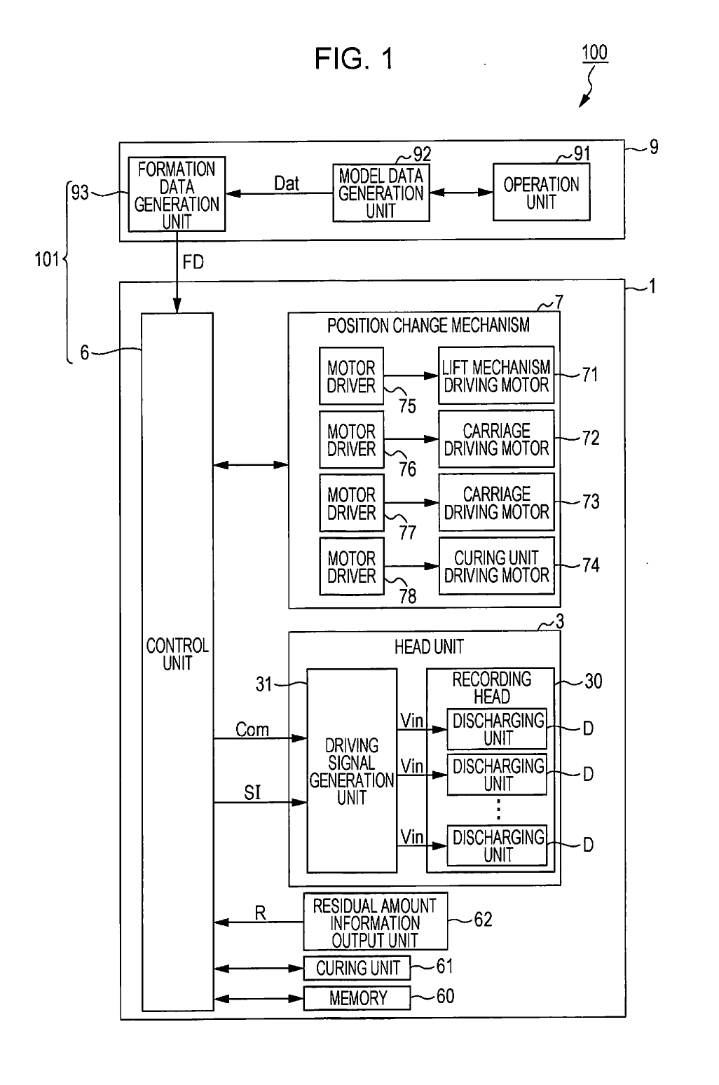

Hereinafter, a configuration of a three-dimensional object formation system 100 including a three-dimensional object formation apparatus 1 according to the embodiment will be described with reference to FIG. 1 to FIG. 9.

FIG. 1 is a functional block diagram showing a configuration of the three-dimensional object formation system 100.

As shown in FIG. 1, the three-dimensional object formation system 100 includes the three-dimensional object formation apparatus 1 which executes a formation process of discharging ink, forming a layered formation body LY having a predetermined thickness AZ with dots formed by the discharged ink, and laminating the formation bodies LY to form a three-dimensional object Obj, and a host computer 9 which executes a data generation process of generating formation body data FD (an example of “designation data”) which designates a shape and a color of each of plural formation bodies LY configuring the three-dimensional object Obj which is formed by the three-dimensional object formation apparatus 1.

### 1.1. Host Computer

As shown in FIG. 1, the host computer 9 includes a CPU (not shown) which controls an operation of each unit of the host computer 9, a display unit (not shown) such as a display, an operation unit 91 such as a keyboard or a mouse, an information memory (not shown) on which a control program of the host computer 9, a driver program of the three-dimensional object formation apparatus 1, and an application program such as computer aided design (CAD) software are recorded, a model data generation unit 92 which generates model data Dat, and a formation data generation unit 93 which executes a data generation process of generating the formation body data FD based on the model data Dat.

Herein, the model data Dat is data showing the shape and the color of the model representing a three-dimensional object Obj which is to be formed by the three-dimensional object formation apparatus 1 and is data for designating the shape and the color of the three-dimensional object Obj. Hereinafter, the color of the three-dimensional object Obj includes a method of applying the plurality of colors when the plurality of colors are applied to the three-dimensional object Obj, that is, the pattern, characters, and other images represented by the plurality of colors applied to the three-dimensional object Obj.

The model data generation unit 92 is a functional block which is realized by execution of the application program recorded on the information memory by the CPU of the host computer 9. The model data generation unit 92 is, for example, a CAD application, and generates the model data Dat which designates the shape and the color of the three-dimensional object Obj based on information which is input by operating the operation unit 91 by a user of the three-dimensional object formation system 100.

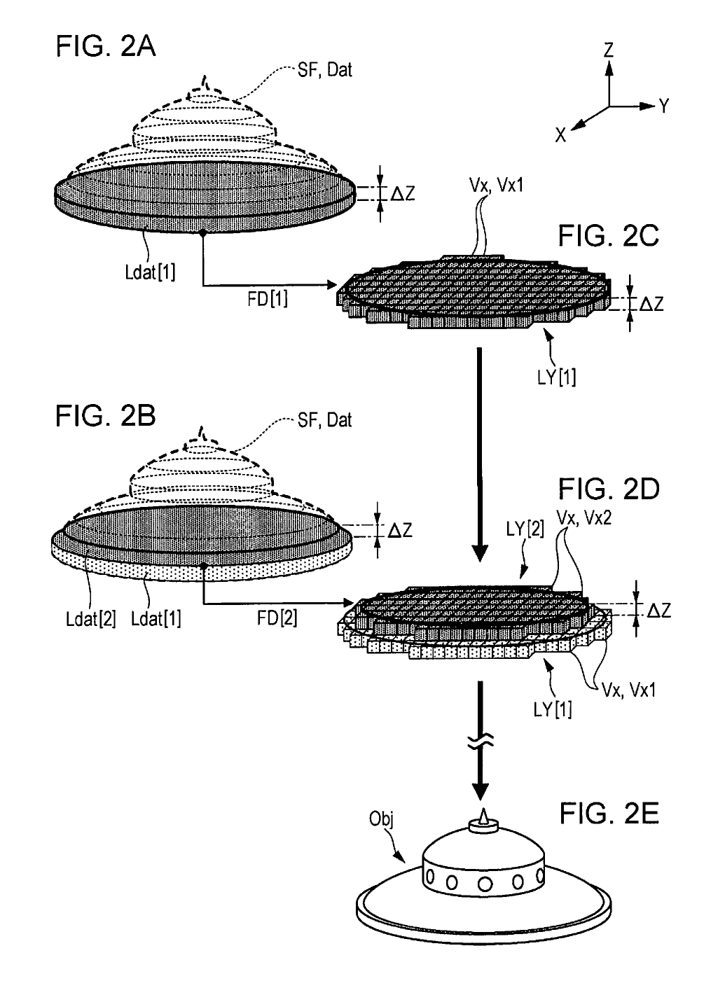

In the embodiment, a case where the model data Dat designates an external shape of the three-dimensional object Obj is assumed. That is, a case where the model data Dat is data which designates a shape of a hollow object in a case where it is assumed that the three-dimensional object Obj is the hollow object, that is, an outer surface SF (see FIGS. 2A to 2E or FIGS. 11A to 11C which will be described later) which is an outline of the three-dimensional object Obj, is assumed. For example, when the three-dimensional object Obj is a sphere, the model data Dat designates a spherical shape which is an outline of the sphere.

However, the invention is not limited to such an embodiment, and the model data Dat may include at least information in which the shape of the outer surface SF of the three-dimensional object Obj can be specified. For example, the model data Dat may designate a shape of the inside of the three-dimensional object Obj with respect to the outer surface SF or a material of the three-dimensional object Obj, in addition to the shape of the outer surface SF of the three-dimensional object Obj and the color of the three-dimensional object Obj.

As the model data Dat, a data format such as additive manufacturing file format (AMF) or stereolithography can be used, for example.

The formation data generation unit 93 is a functional block which is realized by execution of the driver program of the three-dimensional object formation apparatus 1 recorded on the information memory by the CPU of the host computer 9. The formation data generation unit 93 executes a data generation process of generating the formation body data FD which designates a shape and a color of the formation body LY formed by the three-dimensional object formation apparatus 1, based on the model data Dat generated by the model data generation unit 92.

Hereinafter, a case where the three-dimensional object Obj is formed by laminating Q layered formation bodies LY is assumed (Q is a natural number satisfying an expression of Q≧2). The process of forming the formation bodies LY by the three-dimensional object formation apparatus 1 is referred to as a lamination process. That is, the formation process of forming the three-dimensional object Obj by the three-dimensional object formation apparatus 1 includes Q times of the lamination processes. Hereinafter, a formation body LY which is formed in the q-th lamination process among the Q times of the lamination processes included in the formation process is referred to as a formation body LY[q] and the formation body data FD which designates the shape and the color of the formation body LY[q] is referred to as the formation body data FD[q] (q is a natural number satisfying an expression of 1≦q≦Q).

FIGS. 2A to 2E are explanatory diagrams for illustrating a relationship between the shape of the outer surface SF of the three-dimensional object Obj designated by the model data Dat and the formation body LY formed based on the formation body data FD.

As shown in FIGS. 2A and 2B, in order to generate formation body data items FD[1] to FD[Q] which determine the shape and the color of formation bodies LY[1] to LY[Q] having a predetermined thickness AZ, the formation data generation unit 93 slices a three-dimensional shape of the outer surface SF designated by the model data Dat into the predetermined thickness AZ to generate section model data items Ldat[1] to Ldat[Q] respectively corresponding to the formation bodies LY[1] to LY[Q]. Herein, the section model data Ldat is data showing the shape and the color of the section body which is obtained by slicing the shape of the three-dimensional shape designated by the model data Dat. However, the section model data Ldat may be data including the shape and the color of the section when the three-dimensional shape designated by the model data Dat is sliced. FIG. 2A shows the section model data Ldat[1] corresponding to the formation body LY[1] which is formed in the first lamination process and FIG. 2B shows the section model data Ldat[2] corresponding to the formation body LY[2] which is formed in the second lamination process.

Next, in order to form the formation body LY[q] corresponding to the shape and the color shown by the section model data Ldat[q], the formation data generation unit 93 determines the arrangement of dots to be formed by the three-dimensional object formation apparatus 1 and outputs the determined results as the formation body data FD[q]. That is, the formation body data FD[q] is data which designates dots to be formed in each of plural voxels Vx, when the shape and the color shown by the section model data Ldat[q] are segmented in a lattice shape and the shape and the color shown by the section model data Ldat[q] are represented as an assembly of voxels Vx. More specifically, the formation body data FD is data which designates the color and the size of the dot to be formed for forming the three-dimensional object Obj. That is, in the embodiment, the formation body data FD designates the type of ink for forming each dot. The types of ink will be described later.

Herein, the voxel Vx is a cuboid or a cube having a predetermined size and is a cuboid or a cube having the predetermined thickness AZ and a predetermined volume. In the embodiment, the volume and the size of the voxel Vx are determined according to the size of the dots which can be formed by the three-dimensional object formation apparatus 1. Hereinafter, the voxel Vx corresponding to the formation body LY[q] may be referred to as a voxel Vxq.

Hereinafter, a constituent element of the formation body LY configuring the three-dimensional object Obj which is formed corresponding to one voxel Vx and has the predetermined volume and the predetermined thickness AZ may be referred to as a unit structure. The details will be described later, and the unit structure is configured with one or the plurality of dots. That is, the unit structure is one or the plurality of dots which are formed so as to satisfy one voxel Vx. That is, in the embodiment, the formation body data FD designates that one or the plurality of dots are formed in each voxel Vx.

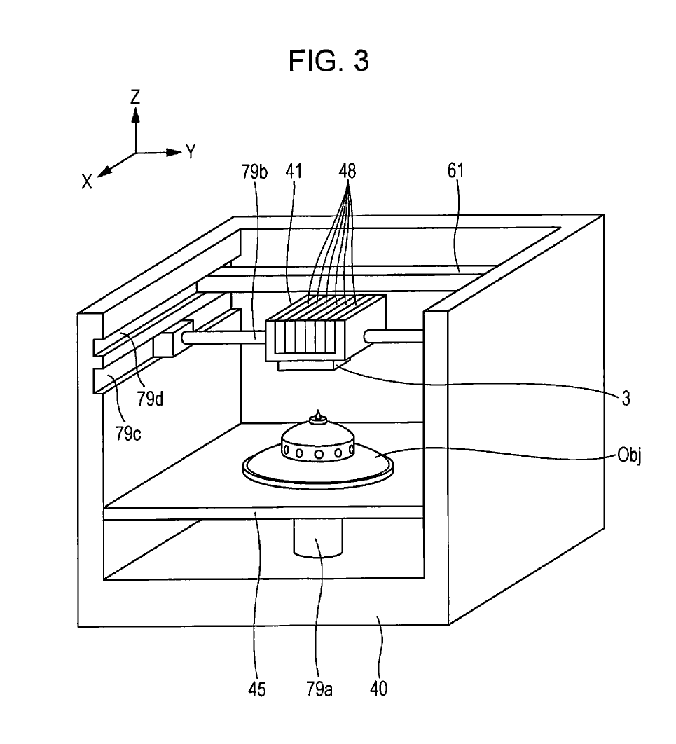

As shown in FIGS. 2C and 2D, the three-dimensional object formation apparatus 1 executes the lamination process of forming the formation body LY[q] when the formation body data FD[q] is supplied from the formation data generation unit 93. FIG. 2C shows the first formation body LY[1] formed on a formation table 45 (see FIG. 3) based on the formation body data FD[1] generated from the section model data Ldat[1] and FIG. 2D shows the second formation body LY[2] formed on the formation body LY[1] based on the formation body data FD[2] generated from the section model data Ldat[2].

The three-dimensional object formation apparatus 1 forms the three-dimensional object Obj shown in FIG. 2E by sequentially laminating the formation bodies LY[1] to LY[Q] according to the supply of the formation body data items FD[1] to FD[Q].

Although will be described later in detail, in principle, the three-dimensional object formation apparatus 1 executes the lamination process so that the formation body LY[q] is configured with only dots having a color designated by the formation body data FD[q], but as an exception, the apparatus may execute the lamination process so that the formation body LY[q] is configured to include dots having a color different from the color designated by the formation body data FD[q].

Hereinafter, among dots formed in a position (voxel Vx) designated by the formation body data FD, a dot formed with ink (having a color) designated by the formation body data FD is referred to as a designation dot and a dot formed with ink which is different from the ink (having a color) designated by the formation body data FD is referred to as a switch dot.

As described above, the model data Dat according to the embodiment designates the shape of the outer surface SF (shape of the outline) of the three-dimensional object Obj. Accordingly, when the three-dimensional object Obj having the shape shown by the model data Dat is reliably formed, the shape of the three-dimensional object Obj becomes a hollow shape only having an outline without any thickness. However, when forming the three-dimensional object Obj, it is preferable to determine the shape of the inside with respect to the outer surface SF, by considering the strength of the three-dimensional object Obj. Specifically, when forming the three-dimensional object Obj, it is preferable that a part or the entirety of the inside of the three-dimensional object Obj with respect to the outer surface SF has a solid structure.

Accordingly, as shown in FIGS. 2A to 2E, the formation data generation unit 93 according to the embodiment generates the formation body data FD so that a part or the entirety of the inside with respect to the outer surface SF has a solid structure, regardless of the fact that the shape designated by the model data Dat is a hollow shape.

Hereinafter, a process of complementing the hollow portion having a shape shown by the model data Dat and generating the section model data Ldat showing the shape in which a part of or the entire hollow portion has a solid structure is referred to as an inner shape complementation process. The inner shape complementation process and the structure of the inside with respect to the outer surface SF designated by the data generated by the inner shape complementation process will be described later in detail.

In the example shown in FIGS. 2A to 2E, a voxel Vx1, in which the unit structures configuring the formation body LY[1] formed in the first lamination process are formed, exists on the lower side (negative Z direction) of a voxel Vx2 in which the unit structures configuring the formation body LY[2] formed in the second lamination process are formed.

However, the voxel Vx1 in which the unit structures are formed may not exist on the lower side of the voxel Vx2 depending on the shape of the three-dimensional object Obj. In such a case, in the formation process, although a dot is attempted to be formed in the voxel Vx2, the dot may fall down and the dot to be formed in the voxel Vx2 may not be formed in a proper position.

Such a problem may highly occur when the three-dimensional object Obj has a so-called overhang shape which is a projected shape with an inclination angle of the outer surface SF which is larger than 90 degrees.

That is, in the three-dimensional object Obj having an overhang shape, the unit structure of the three-dimensional object Obj which can support the portion of the overhang shape does not exist on the lower side of the portion of the overhang shape. Accordingly, when forming the three-dimensional object Obj having the overhang shape, even when the formation bodies LY obtained by slicing the three-dimensional object Obj are simply laminated, the portion of the overhang shape may not be formed in a proper shape. Hereinafter, the portion of the overhang shape is referred to as an overhang portion OH (see FIGS. 11A to 11C).

In order to deal with the problem described above, when the three-dimensional object Obj to be formed has the overhang shape, the three-dimensional object formation system 100 according to the embodiment forms a support SP (see FIGS. 11A to 11C) for supporting the overhang portion OH, during the execution of the formation process. Specifically, when the voxel Vxq satisfying an expression of “q≧2” is a voxel Vx configuring the overhang portion OH, the support SP for supporting the dots formed in the voxel Vxq is formed in a position in the negative Z direction of the voxel Vxq and is overlapped with at least a part of the voxel Vxq when seen in the positive Z direction or the negative Z direction.

Accordingly, the dot to be formed in the voxel Vxq does not fall in the negative Z direction and is properly formed in the voxel Vxq. That is, it is possible to form the three-dimensional object Obj having the overhang portion OH in a proper shape by forming the support SP.

In the embodiment, the formation body data FD includes data for determining the shape of the support SP which supports the three-dimensional object Obj, in addition to the data for determining the shape of the three-dimensional object Obj. That is, in the embodiment, the formation body LY[q] includes both of the portion of the three-dimensional object Obj to be formed in the q-th lamination process and the portion of the support SP to be formed in the q-th lamination process. That is, in the embodiment, the formation body data FD[q] includes both of the data representing the shape and the color of the portion of the three-dimensional object Obj formed as the formation body LY[q] as an assembly of the voxels Vxq, and the data representing the shape of the portion of the support SP formed as the formation body LY[q] as an assembly of the voxels Vxq.

The formation data generation unit 93 according to the embodiment determines whether or not it is necessary to provide the support SP for forming the three-dimensional object Obj based on the model data Dat. When the result of the determination is positive, the formation data generation unit 93 determines the shape of the support SP necessary for forming the three-dimensional object Obj based on the model data Dat. The formation data generation unit 93 generates the section model data Ldat showing the shape of the three-dimensional object Obj and the shape of the support SP.

Hereinafter, the process of complementing the shape shown by the model data Dat by determining the shape of the support SP shown by the section model data Ldat, among the processes of generating the section model data Ldat executed by the formation data generation unit 93 is referred to as a support shape complementation process.

The support SP is preferably configured with a material which is easily removed after the formation of the three-dimensional object Obj, for example, water-soluble ink or ink having a lower melting point than that of the ink for forming the three-dimensional object Obj.

### 1.2. Three-Dimensional Object Formation Apparatus

Next, the three-dimensional object formation apparatus 1 will be described with reference to FIG. 3, in addition to FIG. 1. FIG. 3 is a perspective view schematically showing the structure of the three-dimensional object formation apparatus 1.

As shown in FIG. 1 and FIG. 3, the three-dimensional object formation apparatus 1 includes a housing 40, the formation table 45, a control unit 6 (may be referred to as a “formation control unit”) which controls the operation of each unit of the three-dimensional object formation apparatus 1, a head unit 3 in which a recording head 30 including a discharging unit D discharging ink towards the formation table 45 is provided, a curing unit 61 which cures ink discharged onto the formation table 45, six ink cartridges 48 (an example of a “storage unit”) which stores ink, a carriage 41 on which the head unit 3 and the ink cartridges 48 are mounted, a position change mechanism 7 for changing the positions of the head unit 3, the formation table 45, and the curing unit 61 with respect to the housing 40, a memory 60 on which a control program of the three-dimensional object formation apparatus 1 or other various information items are recorded, a residual amount information output unit 62 (an example of an “output unit”) which outputs residual amount information R showing a residual amount of the ink stored in each ink cartridge 48.

The control unit 6 and the formation data generation unit 93 function as a system control unit 101 which controls the operation of each unit of the three-dimensional object formation system 100.

The residual amount information output unit 62 is, for example, a weight scale which detects weight of ink stored in each ink cartridge 48 and outputs the detected result as the residual amount information R, an illuminometer which measures intensity of light transmitting through the ink when the light is emitted to the ink stored in the each ink cartridge 48 and outputs the measured result as the residual amount information R, or a counter which counts the number of times of discharging of the ink stored in each ink cartridge 48 from the discharging unit D and outputs a counted value as the residual amount information R.

The curing unit 61 is a constituent element for curing ink which is discharged onto the formation table 45, and a light source for emitting an ultraviolet ray to ultraviolet curable ink or a heater for heating resin ink can be exemplified, for example. When the curing unit 61 is a light source of an ultraviolet ray, the curing unit 61 is, for example, provided on the upper side (positive Z direction) of the formation table 45. Meanwhile, when the curing unit 61 is a superheater, the curing unit 61 may be, for example, embedded in the formation table 45 or provided on the lower side of the formation table 45. Hereinafter, the description will be made by assuming that the curing unit 61 is a light source of an ultraviolet ray and the curing unit 61 is positioned in the positive Z direction of the formation table 45.

The six ink cartridges 48 are provided to correspond to a total of six types of ink including a supporting ink for forming the support SP and five colored formation inks for forming the three-dimensional object Obj, one by one. The type of ink corresponding to the ink cartridge 48 is stored in each ink cartridge 48.

The five colored formation inks for forming the three-dimensional object Obj include the chromatic ink including a chromatic color material component, the achromatic ink including an achromatic color material component, and clear (CL) ink having the content of the color material component per unit weight or unit volume which is smaller compared to the chromatic ink and the achromatic ink.

In the embodiment, as the chromatic ink, three colored ink of cyan (CY), magenta (MG), and yellow (YL) are used.

In the embodiment, white (WT) ink is used as the achromatic ink. When the light having a wavelength belonging to the wavelength area (approximately 400 nm to 700 nm) of a visible light is emitted to the white ink, the white ink according to the embodiment is ink which reflects a predetermined percentage or more of light among the emitted light. The expression that “the predetermined percentage or more of light is reflected” has the same meaning as the expression “less than the predetermined percentage or more of light is absorbed or transmitted”, and for example, corresponds to a case where the rate of the intensity of light reflected by the white ink with respect to the intensity of light emitted to the white ink is equal to or greater than the predetermined percentage. In the embodiment, the “predetermined percentage” may be, for example, an arbitrary percentage from 30% to 100%, preferably an arbitrary percentage equal to or greater than 50%, and more preferably an arbitrary percentage equal to or greater than 80%.

In the embodiment, the clear ink is ink having a weight ratio of the color material component included in the clear ink which is equal to or smaller than a predetermined value and having high transparency.

Each ink cartridge 48 may be provided in separate places of the three-dimensional object formation apparatus 1, instead of being mounted on the carriage 41.

As shown in FIG. 1 and FIG. 3, the position change mechanism 7 includes a lift mechanism driving motor 71 for driving a formation table lift mechanism 79a which lifts the formation table 45 up and down in the positive Z direction and the negative Z direction (hereinafter, the positive Z direction and the negative Z direction may be collectively referred to as the “Z axis direction”), a carriage driving motor 72 for moving the carriage 41 along a guide 79b in a positive Y direction and a negative Y direction (hereinafter, the positive Y direction and the negative Y direction may be collectively referred to as the “Y axis direction”), a carriage driving motor 73 for moving the carriage 41 along a guide 79c in a positive X direction and a negative X direction (hereinafter, the positive X direction and the negative X direction may be collectively referred to as the “X axis direction”), and a curing unit driving motor 74 for moving the curing unit 61 along a guide 79d in the positive X direction and the negative X direction.

In addition, the position change mechanism 7 includes a motor driver 75 for driving the lift mechanism driving motor 71, a motor driver 76 for driving the carriage driving motor 72, a motor driver 77 for driving the carriage driving motor 73, and a motor driver 78 for driving the curing unit driving motor 74.

The memory 60 includes an electrically erasable programmable read-only memory (EEPROM) which is one kind of a nonvolatile semiconductor memory which stores the formation body data FD supplied from the host computer 9, a random access memory (RAM) which temporarily stores data which is necessary for executing various processes such as a formation process of forming the three-dimensional object Obj or temporarily develops a control program for controlling each unit of the three-dimensional object formation apparatus 1 so as to execute various processes such as the formation process, and a PROM which is one kind of a nonvolatile semiconductor memory which stores the control program.

The control unit 6 is configured to include a central processing unit (CPU) or a field-programmable gate array (FPGA) and controls the operation of each unit of the three-dimensional object formation apparatus 1 with the operation of the CPU which is performed along with the control program recorded on the memory 60.

The control unit 6 controls the operation of the head unit 3 and the position change mechanism 7 when the formation body data FD is supplied from the host computer 9 and accordingly, controls the execution of the formation process of forming the three-dimensional object Obj corresponding to the model data Dat on the formation table 45.

Specifically, first, the control unit 6 stores the formation body data FD supplied from the host computer 9 in the memory 60. Next, the control unit 6 generates various signals including a driving waveform signal Com and a waveform designation signal SI for driving the discharging unit D by controlling the operation of the head unit 3, based on various data recorded on the memory 60 such as the formation body data FD, and outputs the generated signals. In addition, the control unit 6 generates various signals for controlling the operations of the motor drivers 75 to 78 based on various data recorded on the memory 60 such as the formation body data FD, and outputs the generated signals.

The driving waveform signal Com is an analog signal. Accordingly, the control unit 6 includes a DA conversion signal (not shown) and converts a digital driving waveform signal generated in the CPU included in the control unit 6 into the analog driving waveform signal Com and then outputs the driving waveform signal.

As described above, the control unit 6 controls a relative position of the head unit 3 to the formation table 45 through the control of the motor drivers 75, 76, and 77 and controls a relative position of the curing unit 61 to the formation table 45 through the control of the motor drivers 75 and 78. In addition, the control unit 6 controls discharge or non-discharge of the ink from the discharging unit D, an amount of the ink discharged, and discharge timing of the ink through the control of the head unit 3.

Accordingly, the control unit 6 controls the execution of the lamination process of forming the dots on the formation table 45 and curing the dots formed on the formation table 45 to form the formation body LY, while adjusting the dot size and the dot arrangement regarding the dots which are formed by the ink discharged onto the formation table 45. In addition, the control unit 6 controls the execution of the formation process of laminating the new formation body LY on the formation body LY already formed by repeatedly executing the lamination process and accordingly forming the three-dimensional object Obj corresponding to the model data Dat.

The control unit 6 executes a control mode determination process of determining a control mode for the operation of forming the support SP, in the formation process (and the lamination process) performed by the three-dimensional object formation apparatus 1. In the embodiment, a case having a first control mode, a second control mode, and a third control mode, as the control modes, is assumed.

In the embodiment, a case where the control mode is variable in a unit of the lamination process is assumed. That is, in the embodiment, the control mode determination process is executed during the execution of the formation process and before starting each lamination process configuring the formation process, as a previous stage for executing the lamination process. Accordingly, in the embodiment, the control mode is changed during the execution of the formation process by the control mode determination process.

The control mode determination process and the control mode determined in the control mode determination process will be described later in detail.

As shown in FIG. 1, the head unit 3 includes the recording head 30 including M discharging units D and a driving signal generation unit 31 which generates driving signals Vin for driving the discharging units D (M is a natural number equal to or greater than 1).

Hereinafter, in order to differentiate each of the M discharging units D provided in the recording head 30, the discharging units may be referred to as first, second, . . . , M-th discharging unit, sequentially. In addition, hereinafter, an m-th discharging unit D among the M discharging units D provided in the recording head 30 may be expressed as a discharging unit D[m] (m is a natural number which satisfies an expression of 1≦m≦M). In addition, hereinafter, a driving signal Vin for driving the discharging unit D[m] among the driving signals Vin generated by the driving signal generation unit 31 may be expressed as a driving signal Vin[m].

The driving signal generation unit 31 will be described later in detail.

### 1.3. Recording Head

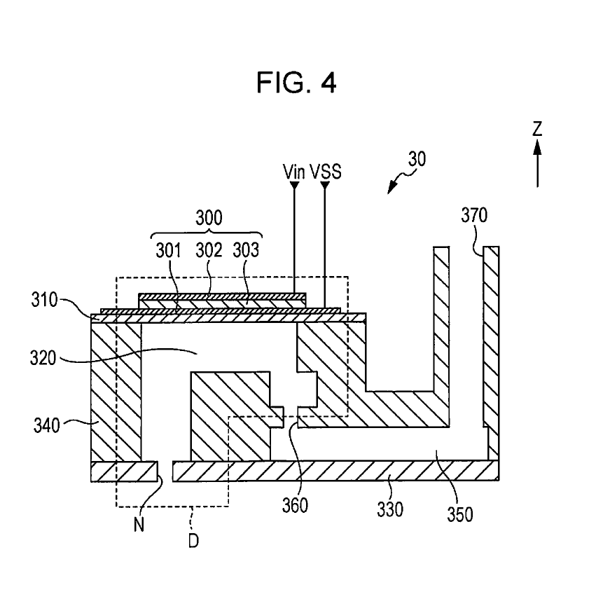

Next, the recording head 30 and the discharging units D provided in the recording head 30 will be described with reference to FIG. 4 to FIG. 6.

FIG. 4 is an example of a schematic partial sectional view of the recording head 30. In this drawing, for convenience of illustration, in the recording head 30, one discharging unit D among the M discharging units D included in the recording head 30, a reservoir 350 which is linked to the one discharging unit D through an ink supply port 360, and an ink inlet 370 for supplying the ink to the reservoir 350 from the ink cartridge 48 are shown.

As shown in FIG. 4, the discharging unit D includes a piezoelectric element 300, a cavity 320 filled with the ink, a nozzle N which is linked to the cavity 320, and a vibration plate 310. The piezoelectric element 300 is driven by the driving signal Vin and accordingly the discharging unit D discharges the ink in the cavity 320 from the nozzle N. The cavity 320 is a space which is partitioned by a cavity plate 340 which is formed in a predetermined shape so as to have a recess, a nozzle plate 330 on which the nozzle N is formed, and the vibration plate 310. The cavity 320 is linked to the reservoir 350 through the ink supply port 360. The reservoir 350 is linked to one ink cartridge 48 through the ink inlet 370.

In the embodiment, a unimorph (monomorph) type as shown in FIG. 4 is used, for example, as the piezoelectric element 300. The piezoelectric element 300 is not limited to the unimorph type, and any type may be used such as a bimorph type or a lamination type, as long as the piezoelectric element 300 can be deformed to discharge the liquid such as ink. The piezoelectric element 300 includes a lower electrode 301, an upper electrode 302, and a piezoelectric body 303 which is provided between the lower electrode 301 and the upper electrode 302. When a potential of the lower electrode 301 is set as a predetermined reference potential VSS, the driving signal Vin is supplied to the upper electrode 302, and accordingly, a voltage is applied between the lower electrode 301 and the upper electrode 302, the piezoelectric element 300 is bent (displaced) in a vertical direction of the drawing according to the applied voltage and as a result, the piezoelectric element 300 is vibrated.

The vibration plate 310 is installed on the upper opening of the cavity plate 340 and the lower electrode 301 is bonded to the vibration plate 310. Accordingly, when the piezoelectric element 300 is vibrated by the driving signal Vin, the vibration plate 310 is also vibrated. The volume of the cavity 320 (pressure in the cavity 320) changes according to the vibration of the vibration plate 310 and the ink filled in the cavity 320 is discharged by the nozzle N. When the ink in the cavity 320 is decreased due to the discharge of the ink, the ink is supplied from the reservoir 350. In addition, the ink is supplied to the reservoir 350 from the ink cartridge 48 through the ink inlet 370.

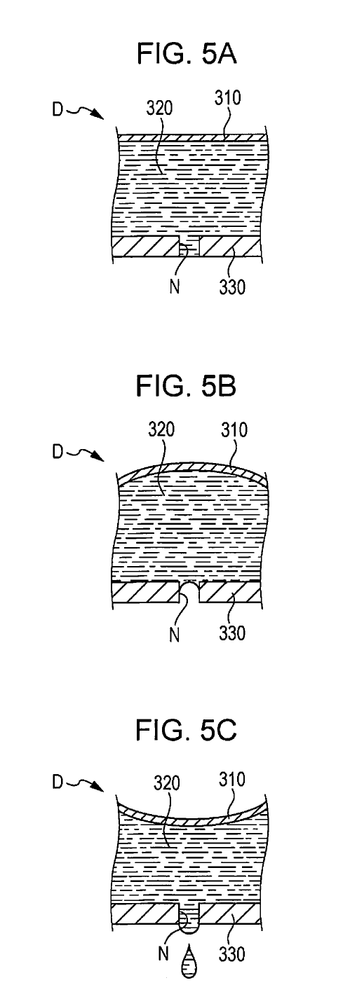

FIGS. 5A to 5C are explanatory diagrams illustrating a discharging operation of the ink from the discharging unit D. In a state shown in FIG. 5A, when the driving signal Vin is supplied to the piezoelectric element 300 included in the discharging unit D from the driving signal generation unit 31, distortion according to an electric field applied between the electrodes occurs in the piezoelectric element 300 and the vibration plate 310 of the discharging unit D is bent in the vertical direction of the drawing. Accordingly, as shown in FIG. 5B, the volume of the cavity 320 of the discharging unit D is expanded, compared to the initial state shown in FIG. 5A. In the state shown in FIG. 5B, when the potential shown by the driving signal Vin is changed, the vibration plate 310 is restored by an elastic restoring force and is moved downwards of the drawing by passing the position of the vibration plate 310 in the initial state, and the volume of the cavity 320 is rapidly contracted as shown in FIG. 5C. At that time, some ink filled in the cavity 320 is discharged as ink droplets from the nozzle N which is linked to the cavity 320, due to compression pressure generated in the cavity 320.

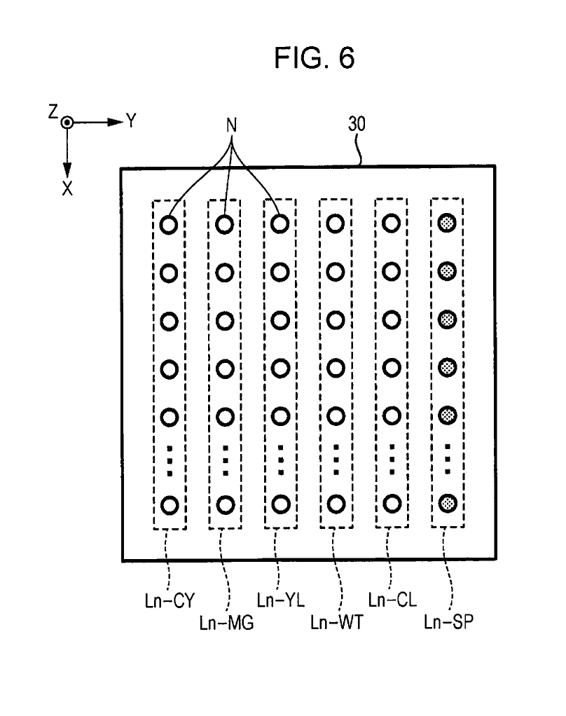

FIG. 6 is an explanatory diagram for illustrating an example of arrangement of M nozzles N provided in the recording head 30 in a plan view of the three-dimensional object formation apparatus 1 in a positive Z direction or a negative Z direction.

As shown in FIG. 6, in the recording head 30, six nozzle arrays Ln formed of a nozzle array Ln-CY formed of a plurality of nozzles N, a nozzle array Ln-MG formed of a plurality of nozzles N, a nozzle array Ln-YL formed of a plurality of nozzles N, a nozzle array Ln-WT formed of a plurality of nozzles N, a nozzle array Ln-CL formed of a plurality of nozzles N, and a nozzle array Ln-SP formed of a plurality of nozzles N, are provided.

Herein, the nozzle N belonging to the nozzle array Ln-CY is a nozzle N provided in the discharging unit D for discharging the cyan (CY) ink, the nozzle N belonging to the nozzle array Ln-MG is a nozzle N provided in the discharging unit D for discharging the magenta (MG) ink, the nozzle N belonging to the nozzle array Ln-YL is a nozzle N provided in the discharging unit D for discharging the yellow (YL) ink, the nozzle N belonging to the nozzle array Ln-WT is a nozzle N provided in the discharging unit D for discharging the white (WT) ink, the nozzle N belonging to the nozzle array Ln-CL is a nozzle N provided in the discharging unit D for discharging the clear (CL) ink, and the nozzle N belonging to the nozzle array Ln-SP is a nozzle N provided in the discharging unit D for discharging the supporting ink.

In the embodiment, as shown in FIG. 6, a case where the plurality of nozzles N configuring each nozzle array Ln are arranged to be lined up in a line in the X axis direction has been used, but for example, the nozzles may be arranged in a so-called zigzag manner in which the positions of some nozzles N (for example, the even-numbered nozzles N) of the plurality of nozzles N configuring each nozzle array Ln and the positions of the other nozzles N (for example, odd-numbered nozzles N) are different from each other in the Y axis direction.

In addition, in each nozzle array Ln, a gap (pitch) between the nozzles N can be appropriately set according to the printing resolution (dpi: dot per inch).

### 1.4. Driving Signal Generation Unit

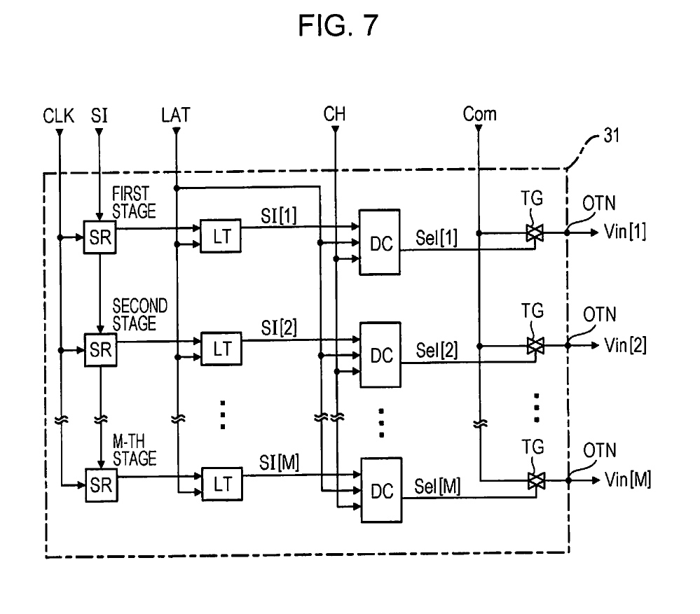

Next, the configuration and the operation of the driving signal generation unit 31 will be described with reference to FIG. 7 to FIG. 9.

FIG. 7 is a block diagram showing the configuration of the driving signal generation unit 31.

As shown in FIG. 7, the driving signal generation unit 31 includes M sets consisting of a shift resistor SR, a latch circuit LT, a decoder DC, and a transmission gate TG so as to respectively correspond to the M discharging units D provided in the recording head 30. Hereinafter, each element configuring the M sets included in the driving signal generation unit 31 and the recording head 30 is referred to as a first, second, . . . , and M-th element in the order from the top of the drawing.

A clock signal CLK, the waveform designation signal SI, a latch signal LAT, a change signal CH, and the driving waveform signal Com are supplied to the driving signal generation unit 31 from the control unit 6.

The waveform designation signal SI is a digital signal which designates an ink amount to be discharged by the discharging unit D and includes the waveform designation signals SI[1] to SI[M].

Among these, a waveform designation signal SI[m] regulates discharge or non-discharge of the ink from the discharging unit D[m] and the amount of the ink discharged with two bits of a high-order bit b1 and a low-order bit b2. Specifically, the waveform designation signal SI[m] regulates any one of discharging of ink of an amount corresponding to a large dot, discharging of ink of an amount corresponding to a medium dot, discharging of ink of an amount corresponding to a small dot, and non-discharging of ink, regarding the discharging unit D[m].

Each shift resistor SR temporarily holds the waveform designation signal SI[m] of two bits corresponding to each stage among the waveform designation signals SI (SI[1] to SI[M]). Specifically, the first, second, . . . , and M-th M shift resistors SR respectively corresponding to the M discharging units D[1] to D[M] are cascade-connected to each other, and the waveform designation signals SI supplied in serial order are transmitted in the order according to the clock signal CLK. When the waveform designation signals SI are transmitted to all of the M shift resistors SR, each of the M shift resistors SR holds the corresponding waveform designation signal SI[m] of 2 bits among the waveform designation signals SI.

Each of the M latch circuits LT simultaneously latches the waveform designation SI[m] of 2 bits corresponding to each stage held by each of the M shift resistors SR, at a timing when the latch signal LAT rises.

However, an operation period which is a period for executing the formation process by the three-dimensional object formation apparatus 1 is configured from a plurality of unit periods Tu. In the embodiment, each unit period Tu is formed of three control periods Ts (Ts1 to Ts3). In the embodiment, the three control periods Ts1 to Ts3 have a duration equivalent to each other. Although will be described later in detail, the unit period Tu is regulated by the latch signal LAT, and the control period Ts is regulated by the latch signal LAT and the change signal CH.

The control unit 6 supplies the waveform designation signal SI[m] to the driving signal generation unit 31 at a timing before the unit period Tu is started. The control unit 6 supplies the latch signal LAT to each latch circuit LT of the driving signal generation unit 31 so that the waveform designation signal SI[m] is latched in each unit period Tu.

The m-th decoder DC decodes the waveform designation signal SI[m] of 2 bits which is latched by the m-th latch circuit LT and outputs a selection signal Sel[m] which is set as any level of a high level (H level) and a low level (L level) in each of the control periods Ts1 to Ts3.

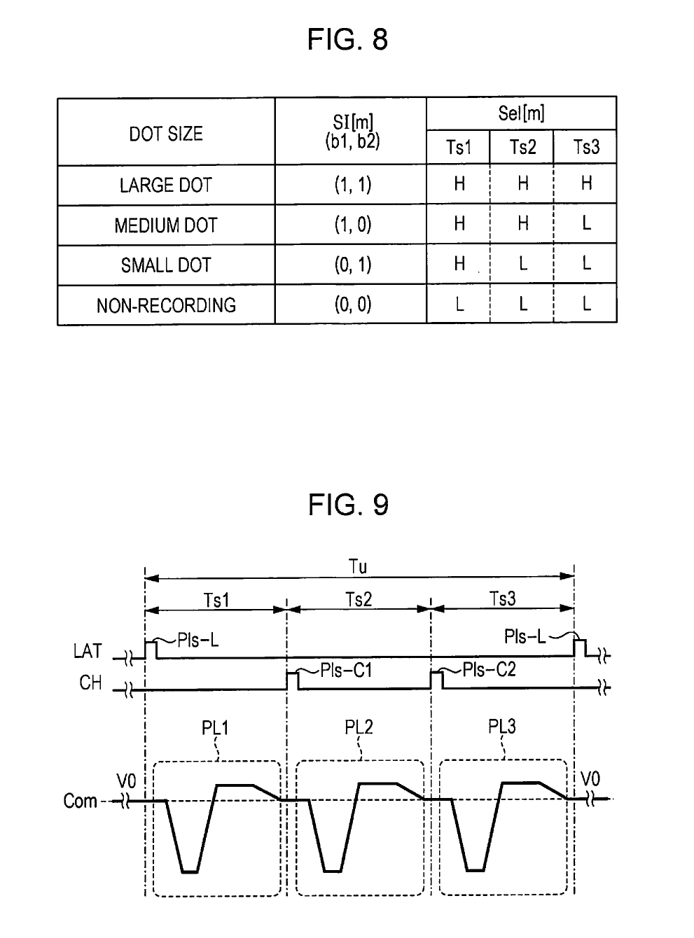

FIG. 8 is an explanatory diagram for illustrating the content of the decoding performed by the decoder DC.

As shown in the drawing, when the content shown by the waveform designation signal SI[m] is (b1,b2)=(1,1), the m-th decoder DC sets the selection signal Sel[m] as the H level in the control periods Ts1 to Ts3, when the content shown by the waveform designation signal SI[m] is (b1,b2)=(1,0), the m-th decoder DC sets the selection signal Sel[m] as the H level in the control periods Ts1 and Ts2 and sets the selection signal Sel[m] as the L level in the control period Ts3, when the content shown by the waveform designation signal SI[m] is (b1,b2)=(0,1), the m-th decoder DC sets the selection signal Sel[m] as the H level in the control period Ts1 and sets the selection signal Sel[m] as the L level in the control periods Ts2 and Ts3, and when the content shown by the waveform designation signal SI[m] is (b1,b2)=(0,0), the m-th decoder DC sets the selection signal Sel[m] as the L level in the control periods Ts1 to Ts3.

As shown in FIG. 7, the M transmission gates TG included in the driving signal generation unit 31 are provided so as to correspond to the M discharging units D included in the recording head 30.

The m-th transmission gate TG is turned on when the selection signal Sel[m] output from the m-th decoder DC is in the H level and is turned off when the selection signal is in the L level. The driving waveform signal Com is supplied to one terminal of each transmission gate TG. The other terminal of the m-th transmission gate TG is electrically connected to an m-th output terminal OTN.

When the selection signal Sel[m] is set as the H level and the m-th transmission gate TG is turned on, the driving waveform signal Com is supplied from the m-th output terminal OTN to the discharging unit DM as the driving signal Vin[m].

Although will be described later in detail, in the embodiment, a potential of the driving waveform signal Com at a timing when the state of the transmission gate TG is switched from on to off (that is, timing of the start and the end of the control periods Ts1 to Ts3) is set as a reference potential V0. Accordingly, when the transmission gate TG is turned off, the potential of the output terminal OTN is maintained as the reference potential V0 by the volume or the like of the piezoelectric element 300 of the discharging unit D[m]. Hereinafter, for convenience of description, the description will be made by assuming that, when the transmission gate TG is turned off, the potential of the driving signal Vin[m] is maintained as the reference potential V0.

As described above, the control unit 6 controls the driving signal generation unit 31 so that the driving signal Vin is supplied to each discharging unit D in each unit period Tu. Accordingly, each discharging unit D can discharge the amount of ink corresponding to a value shown by the waveform designation signal SI in each unit period Tu and can form dots on the formation table 45.

Although will be described later in detail, when the control mode is the first control mode, the control unit 6 generates the waveform designation signal SI based on the designation of the formation body data FD, but when the control mode is the second control mode or the third control mode, the control unit may generate the waveform designation signal SI different from the designation of the formation body data FD. That is, the three-dimensional object formation apparatus 1 forms only the designation dot designated by the formation body data FD in the unit period Tu in which the control mode is the first control mode, but the apparatus may form the switch dot different from the designation of the formation body data FD, in the unit period Tu in which the control mode is the second control mode or the third control mode.

FIG. 9 is a timing chart for illustrating various signals supplied to the driving signal generation unit 31 by the control unit 6 in each unit period Tu.

As shown in FIG. 9, the latch signal LAT includes a pulse waveform Pls-L and the unit period Tu is regulated by the pulse waveform Pls-L. In addition, the change signal CH includes a pulse waveform Pls-C and the unit period Tu is divided into the control periods Ts1 to Ts3 by the pulse waveform Pls-C. Although not shown in the drawing, the control unit 6 synchronizes the waveform designation signal SI with the clock signal CLK in each unit period Tu and supplies the signal to the driving signal generation unit 31 in serial order.

As shown in FIG. 9, driving waveform signal Com includes a waveform PL1 disposed in the control period Ts1, a waveform PL2 disposed in the control period Ts2, and a waveform PL3 disposed in the control period Ts3. Hereinafter, the waveforms PL1 to PL3 may be collectively referred to as the waveform PL. In the embodiment, the potential of the driving waveform signal Com is set as the reference potential V0 at the timing of the start or the end of each control period Ts.

When the selection signal Sel[m] is in the H level in one control period Ts, the driving signal generation unit 31 supplies the waveform PL disposed in the one control period Ts in the driving waveform signal Com to the discharging unit D[m] as the driving signal Vin[m]. On the other hand, when the selection signal Sel[m] is in the L level in one control period Ts, the driving signal generation unit 31 supplies the driving waveform signal Com which is set as the reference potential V0 to the discharging unit D[m] as the driving signal Vin[m].

Accordingly, regarding the driving signal Vin[m] supplied by the driving signal generation unit 31 to the discharging unit D[m] in the unit period Tu, when the value shown by the waveform designation signal SI[m] is (b1,b2) (1,1), the driving signal is a signal including the waveforms PL1 to PL3, when the value shown by the waveform designation signal SI[m] is (b1,b2)=(1,0), the driving signal is a signal including the waveforms PL1 and PL2, when the value shown by the waveform designation signal SI[m] is (b1,b2)=(0,1), the driving signal is a signal including the waveform PL1, and when the value shown by the waveform designation signal SI[m] is (b1,b2)=(0,0), the driving signal is a signal which is set as the reference potential V0.

When the driving signal Vin[m] including one waveform PL is supplied, the discharging unit D[m] discharges a small amount of ink and forms a small dot.

Accordingly, when the value shown by the waveform designation signal SI[m] is (b1,b2)=(0,1) and the driving signal Vin[m] supplied to the discharging unit D[m] includes one waveform PL (PL1) in the unit period Tu, a small amount of ink is discharged from the discharging unit D[m] based on the one waveform PL, and a small dot is formed with the discharged ink.

When the value shown by the waveform designation signal SI[m] is (b1,b2)=(1,0) and the driving signal Vin[m] supplied to the discharging unit D[m] includes two waveforms PL (PL1 and PL2) in the unit period Tu, a small amount of ink is discharged from the discharging unit D[m] twice based on the two waveforms PL, the small amounts of ink which are discharged twice are combined to each other, and accordingly a medium dot is formed.

When the value shown by the waveform designation signal SI[m] is (b1,b2)=(1,1) and the driving signal Vin[m] supplied to the discharging unit D[m] includes three waveforms PL (PL1 to PL3) in the unit period Tu, a small amount of ink is discharged from the discharging unit D[m] three times based on the three waveforms PL, the small amounts of ink which are discharged three times are combined to each other, and accordingly a large dot is formed.

Meanwhile, when the value shown by the waveform designation signal SI[m] is (b1,b2)=(0,0) and the driving signal Vin[m] supplied to the discharging unit D[m] does not include the waveform PL and is maintained as the reference potential V0 in unit period Tu, the ink is not discharged from the discharging unit D[m] and the dot is not formed (the recording is not performed).

In the embodiment, as clearly described above, the medium dot has a size which is double the size of the small dot and the large dot has a size which is three times of that of the small dot.

In the embodiment, the waveform PL of the driving waveform signal Com is determined so that the small amount of ink discharged for forming a small dot is an amount which is approximately ⅓ of the ink necessary for forming a unit structure. That is, the unit structure is configured with any one of three patterns of one large dot, a combination of one medium dot and one small dot, and a combination of three small dots.

In the embodiment, one unit structure is provided with respect to one voxel Vx. That is, in the embodiment, the dots are formed in one voxel Vx with any one of three patterns of one large dot, a combination of one medium dot and one small dot, and a combination of three small dots.

### 2. Data Generation Process and Formation Process

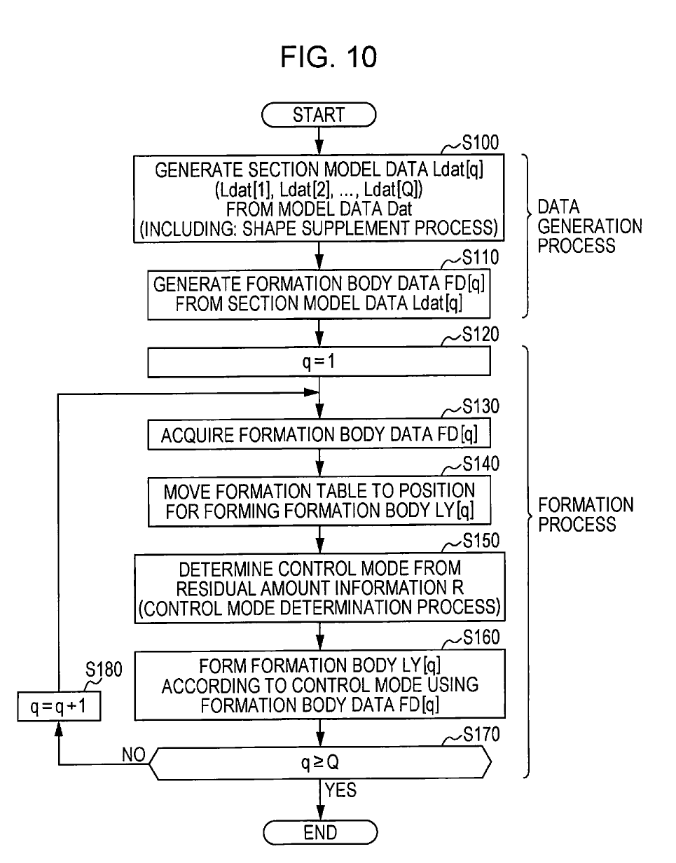

Next, the data generation process and the formation process executed by the three-dimensional object formation system 100 will be described with reference to FIG. 10 to FIG. 14.

### 2.1. Outline of Data Generation Process and Formation Process

FIG. 10 is a flowchart showing an example of the operation of the three-dimensional object formation system 100 when the data generation process and the formation process are executed.

The data generation process is a process executed by the formation data generation unit 93 of the host computer 9 and is started when the model data Dat output by the model data generation unit 92 is acquired by the formation data generation unit 93. The processes in Steps S100 and S110 shown in FIG. 10 correspond to the data generation process.

As shown in FIG. 10, when the data generation process is started, the formation data generation unit 93 generates section model data items Ldat[q] (Ldat[1] to Ldat[Q]) based on the model data Dat output by the model data generation unit 92 (S100).

As described above, in Step S100, the formation data generation unit 93 executes the inner shape complementation process which is a process of complementing the hollow portion having the shape shown by the model data Dat and generating the section model data Ldat so that a part of or the entire area of the inside of the three-dimensional object Obj with respect to the outer surface SF is a solid shape. In addition, in Step S100, the formation data generation unit 93 executes the support shape complementation process of complementing the shape shown by the model data Dat and generating the section model data Ldat showing the shape of the three-dimensional object Obj and the shape of the support SP. Hereinafter, the inner shape complementation process and the support shape complementation process which are processes of complementing the shape shown by the model data Dat are collectively referred to as the shape complementation process. The shape complementation process will be described later in detail.

Then, the formation data generation unit 93 determines the arrangement of the dots to be formed by the three-dimensional object formation apparatus 1 for forming the formation body LY[q] corresponding to the shape and the color shown by the section model data Ldat[q] and outputs the determined result as the formation body data FD[q] (S110).

As described above, the formation data generation unit 93 executes the data generation process shown in Steps S100 and S110 of FIG. 10.

The three-dimensional object formation system 100 executes the formation process after executing the data generation process.

The formation process is a process executed by the three-dimensional object formation apparatus 1 under the control of the control unit 6 and is started when the formation body data FD output by the host computer 9 is acquired by the three-dimensional object formation apparatus 1. The processes in Steps S120 to S180 shown in FIG. 10 correspond to the formation process.

As shown in FIG. 10, the control unit 6 sets “1” for a variable q showing the number of times of execution of the lamination process (S120). Next, the control unit 6 acquires a formation body data FD[q] generated by the formation data generation unit 93 (S130). The control unit 6 controls the lift mechanism driving motor 71 so that the formation table 45 moves to a position for forming the formation body LY[q] (S140).

For the position of the formation table 45 for forming the formation body LY[q], any position may be used as long as it is a position where the ink discharged from the head unit 3 can be landed on a dot formation position (voxel Vxq) designated by the formation body data FD[q]. For example, in Step S150, the control unit 6 may control the position of the formation table 45 so that a space between the formation body LY[q] and the head unit 3 in the Z axis direction is constant. In this case, the control unit 6, for example, may move the formation table 45 in the negative Z direction by an amount of the predetermined thickness AZ during the time after the formation body LY[q] is formed in the q-th lamination process and before the formation of the formation body LY[q+1] in the (q+1)-th lamination process is started.

Next, the control unit 6 executes the control mode determination process of determining the control mode based on the residual amount information R output by the residual amount information output unit 62, more specifically, the information indicating residual amount RSP of the supporting ink among the residual amount information R (S150).

The control unit 6 controls the operations of the head unit 3, the position change mechanism 7, and the curing unit 61 (hereinafter, referred to as the “head unit 3 and the like”) so that the formation body LY[q] is formed in the control mode determined in Step S150 (S160). As clearly described in FIGS. 2A to 2E, the formation body LY[1] is formed on the formation table 45 and the formation body LY[q+1] is formed on the formation body LY[q].

After that, the control unit 6 determines whether or not the variable q satisfies an expression of “q Q” (S170). When the determined result is positive, it is determined that the formation of the three-dimensional object Obj is completed and the formation process is finished, and meanwhile, when the determined result is negative, l is added to the variable q and the process proceeds to Step S140 (S180).

As described above, by executing the data generation process shown in Steps S100 and S110 of FIG. 10, the formation data generation unit 93 of the three-dimensional object formation system 100 generates the formation body data items FD[1] to FD[Q] based on the model data Dat. In addition, by executing the formation processes shown in Steps S120 to S180 of FIG. 10 under the control of the control unit 6, the three-dimensional object formation apparatus 1 of the three-dimensional object formation system 100 forms the three-dimensional object Obj so as to reproduce the shape and the color of the model data Dat.

FIG. 10 is merely an example of the flow of the data generation process and the formation process. For example, in FIG. 10, the formation process is started after completing the data generation process, but the invention is not limited to this embodiment, and the formation process may be started before completing the data generation process. For example, when the formation body data FD[q] is generated in the data generation process, the formation process (that is, the q-th lamination process) of forming the formation body LY[q] may be executed after acquiring the formation body data FD[q], without waiting for the generation of the next formation body data FD[q+1].

### 2.2. Inner Shape Complementation Process

As described above, in Step S100, the formation data generation unit 93 executes the inner shape complementation process of complementing a part of or the entire hollow portion having the shape of the outer surface SF of the three-dimensional object Obj designated by the model data Dat and generating the section model data Ldat so that a part or the entirety of the inner area with respect to the outer surface SF has a solid structure.

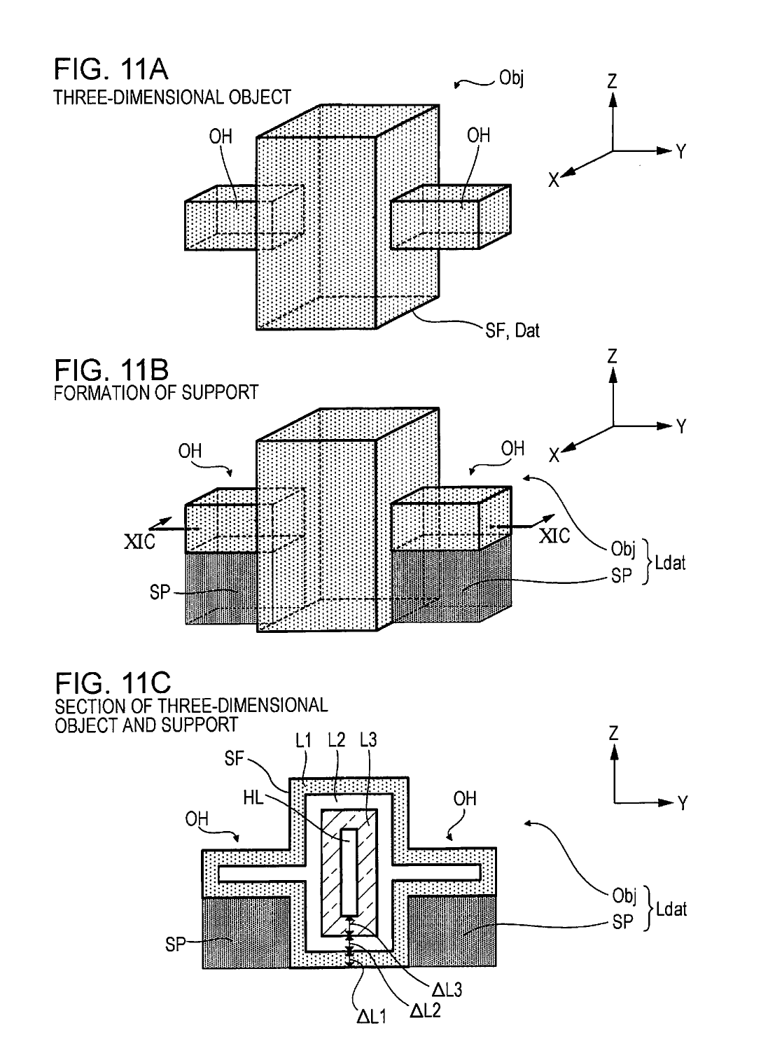

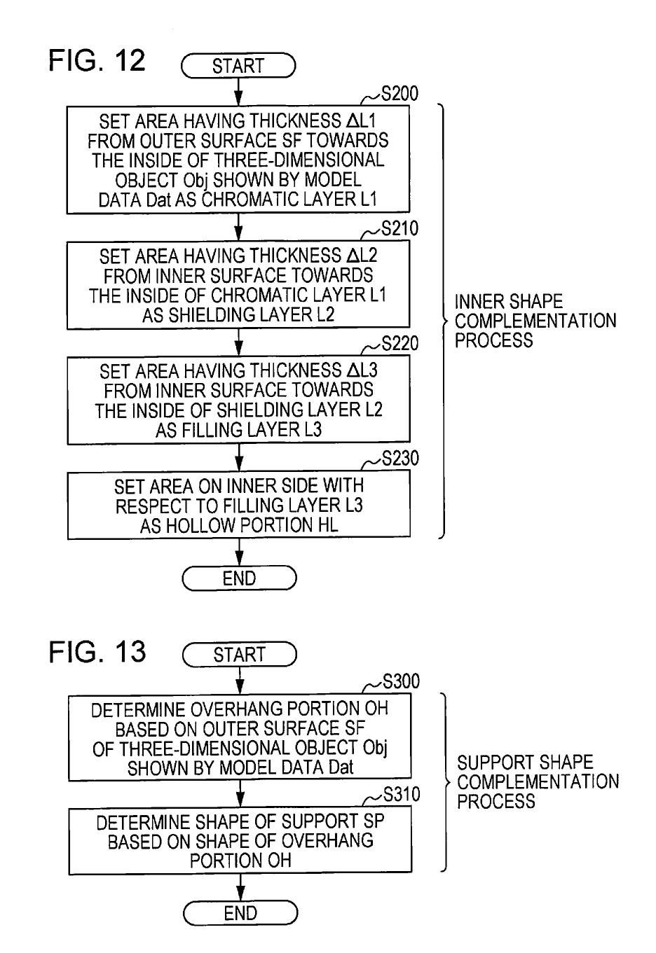

Hereinafter, an example of the structure of the inside of the three-dimensional object Obj with respect to the outer surface SF generated based on the section model data Ldat and the inner shape complementation process of determining the structure of the inside with respect to the outer surface SF and generating the section model data Ldat will be described with reference to FIG. 11A to FIG. 12.

First, the structure of the inside of the three-dimensional object Obj with respect to the outer surface SF will be described with reference to FIGS. 11A to 11C.

Herein, FIG. 11A is a perspective view of the three-dimensional object Obj. As described above, the three-dimensional object Obj shown in FIG. 11A has the outer surface SF having a shape designated by the model data Dat. FIG. 11B is a perspective view showing the three-dimensional object Obj shown in FIG. 11A and the support SP formed when forming the three-dimensional object Obj. In this drawing, a case where the support SP is formed in two locations is exemplified. FIG. 11C is a sectional view when the three-dimensional object Obj and the support SP shown in FIG. 11B are sectioned along a plane parallel to the X axis and the Y axis through a linear line XIC-XIC. In FIGS. 11A to 11C, for convenience of illustration, a case of forming the three-dimensional object Obj having a shape different from those in FIG. 2A to FIG. 3 is assumed.

As shown in FIG. 11C, the three-dimensional object Obj formed by the three-dimensional object formation system 100 includes three layers of a chromatic layer L1, a shielding layer L2, and a filling layer L3 in the order from the outer surface SF which is an outline of the three-dimensional object Obj to the inside of the three-dimensional object Obj and further includes a hollow portion HL in the inside with respect to the third layer.

Herein, the chromatic layer L1 is a layer formed with the ink including the chromatic ink and is a layer including the outer surface SF for expressing the color of the three-dimensional object Obj. The shielding layer L2 is a layer formed using the white ink, for example, and is a layer for preventing the color of the inner portion of the three-dimensional object Obj with respect to the chromatic layer L1 from transmitting the chromatic layer L1 and being visualized from the outside of the three-dimensional object Obj. That is, the chromatic layer L1 and the shielding layer L2 are provided in order to properly express the color to be displayed by the three-dimensional object Obj. Hereinafter, among the three-dimensional object Obj, the chromatic layer L1 and the shielding layer L2 provided in order to properly express the color to be displayed by the three-dimensional object Obj may be referred to as an outer area LOUT of the three-dimensional object Obj.

The filing layer L3 is a layer provided in order to ensure the strength of the three-dimensional object Obj and is formed using the clear ink in principle. Hereinafter, among the three-dimensional object Obj, the filling layer L3 and the hollow portion HL provided in the inside with respect to the outer area LOUT may be referred to as an inner area LIN of the three-dimensional object Obj (or the “inside of the three-dimensional object Obj”).

In the embodiment, for simplification, as shown in FIG. 11C, a case where each layer is provided so that the chromatic layer L1 has an approximately even thickness ΔL1, the shielding layer L2 has an approximately even thickness ΔL2, and the filling layer L3 has an approximately even thickness ΔL3, is assumed, but the thickness of each layer may not be approximately uniform.

The expression of “approximately uniform” or “approximately the same” in this specification include a case where the state can be assumed as uniform or the same when ignoring various errors, in addition to a case where the state is completely uniform or the same. The various errors which can be ignored include a discrete error generated when the shape shown by the model data Dat is represented as an assembly of the voxels Vx.

FIG. 12 is a flowchart showing an example of the operation of the formation data generation unit 93 when executing the inner shape complementation process.

As shown in FIG. 12, the formation data generation unit 93 first determines an area of the model of the three-dimensional object Obj represented by the model data Dat having the thickness ΔL1 from the outer surface SF of the three-dimensional object Obj to the inside of the three-dimensional object Obj, as the chromatic layer L1 (S200). The formation data generation unit 93 determines an area having the thickness ΔL2 from the inner surface of the chromatic layer L1 to the inside of the three-dimensional object Obj, as the shielding layer L2 (S210). The formation data generation unit 93 determines an area having the thickness ΔL3 from the inner surface of the shielding layer L2 to the inside of the three-dimensional object Obj, as the filling layer L3 (S220). The formation data generation unit 93 determines a portion of the inside of the three-dimensional object Obj with respect to the filling layer L3 as the hollow portion HL (S230).

By executing the inner shape complementation process described above, the formation data generation unit 93 generates the section model data Ldat for forming the three-dimensional object Obj including the chromatic layer L1, the shielding layer L2, and the filling layer L3, as shown in FIG. 11C.

The inner structure of the three-dimensional object Obj according to the embodiment is merely an example and the three-dimensional object formation system 100 may form the three-dimensional object Obj including at least the chromatic layer L1. For example, the three-dimensional object formation system 100 may form the three-dimensional object Obj including only the chromatic layer L1 or may form the three-dimensional object Obj formed of the chromatic layer L1 and the filling layer L3.

### 2.3. Support Shape Complementation Process

As described above, in Step S100, the formation data generation unit 93 executes the support shape complementation process which is a process of complementing the shape shown by the model data Dat and generating the section model data Ldat showing both shapes of the shape of the three-dimensional object Obj and the shape of the support SP.

Hereinafter, an example of the shape of the support SP generated based on the section model data Ldat and the support shape complementation process of determining the shape of the support SP and generating the section model data Ldat will be described with reference to FIGS. 11A to 11C and FIG. 13.

As shown in FIG. 11A, the three-dimensional object Obj formed by the three-dimensional object formation system 100 includes two overhang portions OH at the right and left sides (positive Y direction and negative Y direction) in the drawing.

As clearly shown in FIG. 11A, the formation body LY configuring the three-dimensional object Obj is formed in the negative Z direction of the two overhang portions OH. Accordingly, when forming the three-dimensional object Obj by laminating only the formation bodies LY configuring the three-dimensional object Obj, each overhang portion OH may fall in the negative Z direction. In this case, it is difficult to properly form each overhang portion OH in a position designated by the model data Dat.

With respect to this, the three-dimensional object formation system 100 according to the embodiment, as shown in FIGS. 11B and 11C, when forming the three-dimensional object Obj, the support SP is formed in the negative Z direction of each overhang portion OH. That is, in the embodiment, the formation body LY configuring the support SP is formed in the negative Z direction of each overhang portion OH. In this case, since the support SP supports each overhang portion OH during executing the formation process, it is possible to prevent falling of each overhang portion OH in the formation process. Accordingly, in the embodiment, each overhang portion OH can be properly formed in a position designated by the model data Dat.

FIG. 13 is a flowchart showing an example of the operation of the formation data generation unit 93 when executing the support shape complementation process.

As shown in FIG. 13, the formation data generation unit 93 first specifies a range of the overhang portion OH of the three-dimensional object Obj, that is, the position and the shape of the overhang portion OH of the three-dimensional object Obj, based on the shape of the outer surface SF designated by the model data Dat (S300).

The specification of the overhang portion OH may be executed by any methods. For example, the formation data generation unit 93 according to the embodiment first divides the outer surface SF into a plurality of areas and sets a focus point for each of the plurality of areas. Next, the formation data generation unit 93 specifies a portion of the three-dimensional object Obj in the positive Z direction of the focus point as the overhang portion OH, when an angle formed by a normal vector which is a normal vector of each focus point of the outer surface SF and is from the inside towards the outside of the three-dimensional object Obj and a vector facing the positive Z direction is equal to or greater than a predetermined angle which is larger than 90 degrees.

When the three-dimensional object Obj does not include the overhang portion OH, the formation data generation unit 93 finishes the support shape complementation process shown in FIG. 13 (not shown).

Next, the formation data generation unit 93 designates the shape of the support SP (S310). Specifically, the formation data generation unit 93 designates the shape of the support SP by designating an area in the negative Z direction of the overhang portion OH specified in Step S300 which is an area on the outer side with respect to the outer surface SF of the three-dimensional object Obj, as an area where the support SP is to be formed.

As described above, the formation data generation unit 93 according to the embodiment generates the section model data Ldat for forming the support SP by executing the support shape complementation process shown in Steps S300 and S310.

The support shape complementation process according to the embodiment is an example, and the formation data generation unit 93 may determine the shape of the support SP so that the shape when the support SP and the three-dimensional object Obj are assumed to be integrated to each other, is a shape not including the overhang shape.

### 2.4. Control Mode Determination Process

In Step S150, the control unit 6 executes the control mode determination process which is a process of determining the control mode based on the residual amount information R. Hereinafter, the control mode determination process and the control mode determined in the control mode determination process will be described.

As described above, the control unit 6 of the three-dimensional object formation apparatus 1 according to the embodiment can form the support SP and control the execution of the formation process in the three control mode of the first control mode, the second control mode, and the third control mode. More specifically, the control unit 6 selects one control mode from the three control modes in the control mode determination process and executes the lamination process of forming the formation body LY[q] in the one control mode.

FIG. 14 is an explanatory diagram for illustrating selection (determination) of the control mode in the control mode determination process executed by the control unit 6.

As shown in the drawing, the control unit 6 selects the second control mode as the control mode, when the residual amount RSP of the supporting ink shown by the residual amount information R satisfies an expression of “RSP≦α1”. A reference amount α1 (an example of a “first reference amount”) is a value satisfying an expression of “α1≧0”.

The control unit 6 selects the third control mode as the control mode, when the residual amount RSP of the supporting ink shown by the residual amount information R satisfies an expression of “α1<RSP≦α2”. A reference amount α2 (an example of a “second reference amount”) is a value satisfying an expression of “α1<α2”.

The control unit 6 selects the first control mode as the control mode, when the residual amount RSP of the supporting ink shown by the residual amount information R satisfies an expression of “α2<RSP”.

Herein, the first control mode is a control mode of forming the support SP using the ink (an example of “first liquid”) originally intended to be used in the formation of the support SP. That is, when the execution of the formation process is controlled in the first control mode, the support SP is formed using the supporting ink.

In Step S150, when the residual amount RSP of the supporting ink is greater than the reference amount α2 and is sufficient amount for executing the lamination process, the control unit 6 selects the first control mode so that the support SP is formed using only the supporting ink expected to be originally used in the formation of the support SP.

In this case, in Step S160, the control unit 6 controls the operation of the head unit 3 and the like so that each dot configuring the formation body LY[q] is formed with the ink designated by the formation body data FD[q]. That is, when the control mode is the first control mode, one or all of the plurality of dots configuring the formation body LY[q] are designation dots.

The second control mode is a control mode of controlling the execution of the formation process so that the support SP is formed using ink other than the ink originally intended to be used in the formation of the support SP. That is, when the execution of the formation process is controlled in the second control mode, the support SP is formed using ink other than the supporting ink, that is, at least one kind of ink of the chromatic ink, the achromatic ink, and the clear ink. The ink used in the formation of the support SP as a replacement of the ink originally intended to be used in the formation of the support SP may be referred to as switch ink (an example of “second liquid”).

In Step S150, when the residual amount RSP of the supporting ink is equal to or smaller than the reference amount α1 and the supporting ink may be insufficient in the execution of the lamination process, the control unit 6 selects the second control mode so that the support SP is formed with the switch ink.

When the control mode is the second control mode and the formation body LY[q] includes the support SP, the control unit 6 controls the operation of the head unit 3 and the like, so that each dot forming the support SP in the formation body LY[q] is formed of the switch dot which is different from the designation of the formation body data FD[q], in Step S160.

More specifically, when the control mode is the second control mode and one dot formed in the formation process is the dot forming the support SP, the control unit 6 stops the discharging of the ink from one discharging unit D designated by the formation body data FD for the discharging of the ink for forming the one dot. The control unit 6 generates the waveform designation signal SI for designating the discharging of the switch ink for forming the one dot, from another discharging unit D which can discharge the switch ink, instead of the one discharging unit D. Accordingly, one dot is formed as the switch dot formed with the switch ink discharged from the other discharging unit D, instead of the designation dot formed with the supporting ink discharged from the one discharging unit D.

Hereinafter, the formation of the switch dot with the other discharging unit D which can discharge the switch ink, instead of the one discharging unit D for forming the designation dot corresponding to the formation body data FD may be expressed as “complementation of one discharging unit D with another discharging unit D”.

When the control mode is the second control mode and the formation body LY[q] includes the three-dimensional object Obj, the control unit 6 controls the operation of the head unit 3 and the like, so that each dot configuring the three-dimensional object Obj in the formation body LY[q] is formed of the designation dot corresponding to the designation of body data FD[q], in Step S160.

The third control mode is a control mode of controlling the execution of the formation process so that the entire support SP is formed using both of the ink originally intended to be used in the formation of the support SP and the switch ink. That is, when the execution of the formation process is controlled in the third control mode, the support SP is formed using both of the supporting ink and the ink other than the supporting ink.

In Step S150, when the residual amount RSP of the supporting ink is greater than the reference amount α1 and equal to or smaller than the reference amount α2 and is not sufficient amount for executing the lamination process, the control unit 6 selects the third control mode so that the support SP is formed using both of the support ink and the switch ink.

When the control mode is the third control mode and the formation body LY[q] includes the support SP, in Step S160, the control unit 6 controls the operation of the head unit 3 and the like, so that the plurality of dots forming the support SP in the formation body LY[q] include both of the designation dot and the switch dot.

More specifically, when the control mode is the third control mode, one dot formed in the formation process is the dot configuring the support SP, and the formation body data FD designates one discharging unit D as a discharging unit D for forming the one dot, the control unit 6 generates the waveform designation signal SI for designating the one discharging unit D or any one discharging unit D among other discharging units D which can discharge the switch ink, instead of the one discharging unit D, as a discharging unit D for forming the one dot. Accordingly, one dot is formed as the designation dot formed with the supporting ink discharged from the one discharging unit D or the switch dot formed with the switch ink discharged from the other discharging unit D.

Even when the control mode is the third control mode, the control unit 6 controls the operation of the head unit 3 and the like, so that each dot for configuring the three-dimensional object Obj is the designation dot, in Step S160.

### 3. Conclusion of Embodiment

As described above, the control unit 6 according to the embodiment can control the head unit 3 and the like in the three control modes of the first control mode of forming the support SP with the supporting ink, the second control mode of forming the support SP with the switch ink, and the third control mode of forming the support SP with the supporting ink and the switch ink. That is, in the embodiment, the formation process is executed in the control mode corresponding to the residual amount RSP of the supporting ink.

Accordingly, when the residual amount RSP of the supporting ink originally intended to be used in the formation of the support SP is not sufficient, it is possible to form the support SP using the switch ink other than the supporting ink, such as the chromatic ink, the achromatic ink, and the clear ink. Accordingly, it is possible to decrease a possibility of generation of the stopping of the formation process due to the insufficient supporting ink, by comparing to a case of forming the support SP using only the supporting ink.

When the stopping and the restarting of the formation process are performed, regarding dots configuring the formation bodies LY laminated in the lamination process being executed when stopping the formation process, and the dots configuring the formation bodies LY laminated in the lamination process which is one step before the lamination process being executed when stopping the formation process, the time of contacting air, for example, is increased by the time from the stopping to the restarting of the process. That is, in this case, variations in the curing time for curing the dots are generated due to the stopping of the formation process. Accordingly, variations in the degree of curing may be generated between the plurality of dots configuring the three-dimensional object Obj. In this case, color unevenness, concavities and convexities, or a decrease in strength may be generated in the formed three-dimensional object Obj, due to the variations in the degree of curing between the dots. That is, when the formation process is stopped, the quality of the three-dimensional object Obj may be decreased, compared to a case where the formation process is not stopped.

In addition, when the formation process is stopped due to the insufficient supporting ink, it is difficult to continue the formation process, if a user of the three-dimensional object formation system 100 does not replace the ink cartridge 48 corresponding to the supporting ink during the execution of the formation process. That is, in the formation process, a user is forced to perform the replacement operation of the ink cartridge 48 and this may lead to a decrease in convenience according to the formation process.

With respect to this, in the embodiment, since it is possible to reduce a possibility of generation of the stopping of the formation process due to the insufficient supporting ink, it is possible to prevent a decrease in quality of the three-dimensional object Obj due to the stopping of the formation process or a decrease in convenience due to the replacement operation of the ink cartridge 48 in the formation process.

In general, the cost of the supporting ink is low, compared to supporting ink. Accordingly, as in the embodiment, by executing the formation process in the control mode corresponding to the residual amount RSP of the supporting ink, it is possible to decrease the possibility of generation of the stopping of the formation process and to prevent an increase in cost due to the use of the switch ink.

In the embodiment, when the control mode is the second control mode or the third control mode, the switch ink which is a replacement of the supporting ink is preferably clear ink. However, the achromatic ink such as white ink may be used, as the switch ink.

The control unit 6 according to the embodiment selects a discharging unit D which discharges the clear ink as a discharging unit D for discharging the switch ink, when the residual amount of the clear ink is equal to or greater than a predetermined amount, and selects a discharging unit D which discharges the white ink, as a discharging unit D for discharging the switch ink, when the residual amount of the clear ink is smaller than a predetermined amount.

### B. Modification Examples

The above embodiment can be modified in various manners. Specific modified embodiments will be described hereinafter. Two or more embodiments arbitrarily selected from the below examples can be suitably combined with each other in a range not contradicting each other.

In the modification examples below, the same reference numerals used in the above description will be used for the elements exhibiting the same operations or functions as those in the above embodiment and the specific description thereof will be suitably omitted.

### Modification Example 1

In the embodiment described above, the control unit 6 can change the control mode in the unit of the formation body LY[q] by executing the control mode determination process for each time executing the lamination process, but the invention is not limited to this embodiment, and the control mode may be changed in an arbitrary unit such as in the unit of the discharging unit D or the unit of the unit period Tu.

For example, when the control mode can be changed in the unit of the discharging unit D, the control unit 6 may determine the control mode based on the residual amount RSP of the supporting ink, when generating the waveform designation signal SI[m] corresponding to the discharging unit D[m] designated for the discharging of the supporting ink from the formation body data FD.

For example, when the control mode can be changed in the unit of the unit period Tu, that is, when the control mode can be changed in the unit of M discharging units D, the control unit 6 may determine the control mode based on the residual amount RSP of the supporting ink, when generating the waveform designation signals SI[1] to SI[M] corresponding to the discharging units D[1] to D[M].

In addition, the control unit 6 may change the control mode in the unit of the formation of the three-dimensional object Obj. In this case, the control unit 6 may determine the control mode based on the consumption amount of the supporting ink necessary for the formation of the three-dimensional object Obj and the residual amount RSP of the supporting ink, before starting the formation process.

### Modification Example 2

In the embodiment and the modification example described above, in the third control mode, all of the supports SP are formed using both of the supporting ink and the switch ink, but the invention is not limited to the embodiment, and in the third control mode, a part of the support SP may be formed with any one of the supporting ink and the switch ink.

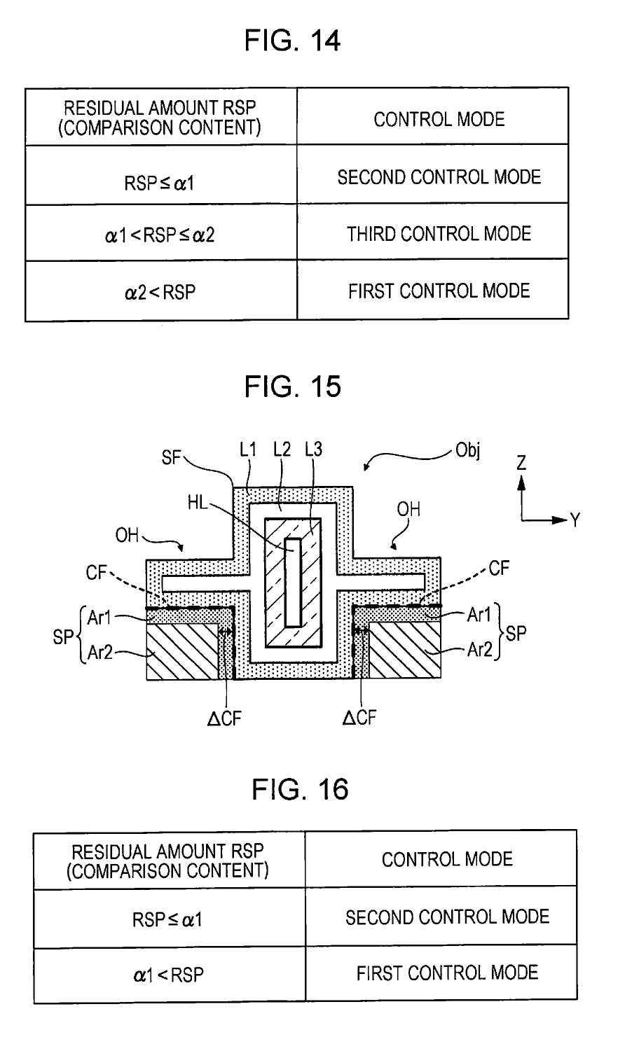

Hereinafter, the support SP formed in the third control mode according to this modification example will be described with reference to FIG. 15.

FIG. 15 is a sectional view of the three-dimensional object Obj formed in the formation process, and the support SP for supporting the three-dimensional object Obj which is the support SP formed in the third control mode according to this modification example. The three-dimensional object Obj shown in FIG. 15 is the same as the three-dimensional object Obj shown in FIGS. 11A to 11C. The three-dimensional object Obj shown in FIG. 15 is the same as the support SP shown in FIGS. 11A to 11C, except for that the support SP is formed by sectioning a connection area Ar1 and a non-connection area Ar2.

As shown in FIG. 15, when the third control mode is selected as the control mode in the control mode determination process shown in Step S150 of FIG. 10, the control unit 6 according to this modification example first specifies a position of a contact surface CF of the three-dimensional object Obj and the support SP to be formed for forming the three-dimensional object Obj. Next, the control unit 6 according to this modification example designates an area having a distance from the contact surface CF which is equal to or shorter than a predetermined distance LCF, as the connection area Ar1. The control unit 6 according to this modification example designates an area of the support SP which is other than the connection area Ar1, as the non-connection area Ar2. After that, in Step S160 of FIG. 10, the control unit 6 according to this modification example generates the waveform designation signal SI for designating the formation of the connection area Ar1 using only the supporting ink and the formation of the non-connection area Ar2 using both of the supporting ink and the switch ink.

As described above, the three-dimensional object formation system 100 according to the modification example sections the connection area Ar1 and the non-connection area Ar2 of the support SP and forms the connection area Ar1 using the supporting ink, in the third control mode. Accordingly, it is easily separate the support SP and the three-dimensional object Obj after forming the three-dimensional object Obj, compared to a case of forming all supports SP using the switch ink or a case of forming all supports SP using both of the supporting ink and the switch ink.

### Modification Example 3

In the embodiment and the modification examples described above, the control unit 6 can control the execution of the formation process in the three control modes of the first control mode, the second control mode, and the third control mode, but the invention is not limited to the embodiment, and the control unit 6 may control the execution of the formation process in at least two control modes among the three control modes. Specifically, the control unit 6 may control the execution of the formation process in the first control mode and the second control mode or may control the execution of the formation process in the first control mode and the third control mode.

FIG. 16 is an explanatory diagram for illustrating determination of the control mode, when the execution of the formation process can be controlled by the control unit 6 according to this modification example in the two control modes of the first control mode and the second control mode.

As shown in the drawing, the control unit 6 according to this modification example may select the second control mode as the control mode, when the residual amount RSP of the supporting ink satisfies an expression of “RSP≦α1”, and may select the first control mode as the control mode, when the residual amount RSP of the supporting ink satisfies an expression of “α1<RSP”.

### Modification Example 4

In the embodiment and the modification examples described above, the ink which can be discharged by the three-dimensional object formation apparatus 1 is total six types of ink including three chromatic inks, one achromatic ink, the clear ink, and the supporting ink, but the invention is not limited to this embodiment, and three-dimensional object formation apparatus 1 may discharge at least two kinds of ink including the supporting ink and ink which is type different from that of the supporting ink.

In the embodiment and the modification examples described above, the residual amount information R shows the residual amount of the ink stored in each of the plurality of ink cartridges 48, but the residual amount information R may show the residual amount of the supporting ink used in the formation of the support SP.

### Modification Example 5

In the embodiment and the modification examples described above, the clear ink or the white ink is used, as the switch ink, but the invention is not limited to the embodiment, and the switch ink may be any kinds of ink, as long as it is ink which can be discharged by the three-dimensional object formation apparatus 1.

### Modification Example 6

In the embodiment and the modification examples described above, the three-dimensional object formation apparatus 1 executes the formation of the three-dimensional object Obj and the formation of the support SP by laminating the formation bodies LY which are formed by curing the supporting ink, but the invention is not limited to the embodiment, and formation bodies LY may be formed by solidifying powder spread in a layered shape by curable formation ink and the formation of the three-dimensional object Obj and the formation of the support SP may be executed by laminating the formed formation bodies LY.

In this case, the three-dimensional object formation apparatus 1 may include a powder layer formation unit (not shown) which spreads the powder on the formation table 45 to have the predetermined thickness AZ to form a powder layer PW and a powder discarding unit (not shown) which discards the powder (powder other than powder solidified by the formation ink) not configuring the three-dimensional object Obj or the support SP after forming the three-dimensional object Obj and the support SP. Hereinafter, the powder layer PW for forming the formation body LY[q] is referred to as the powder layer PW[q].

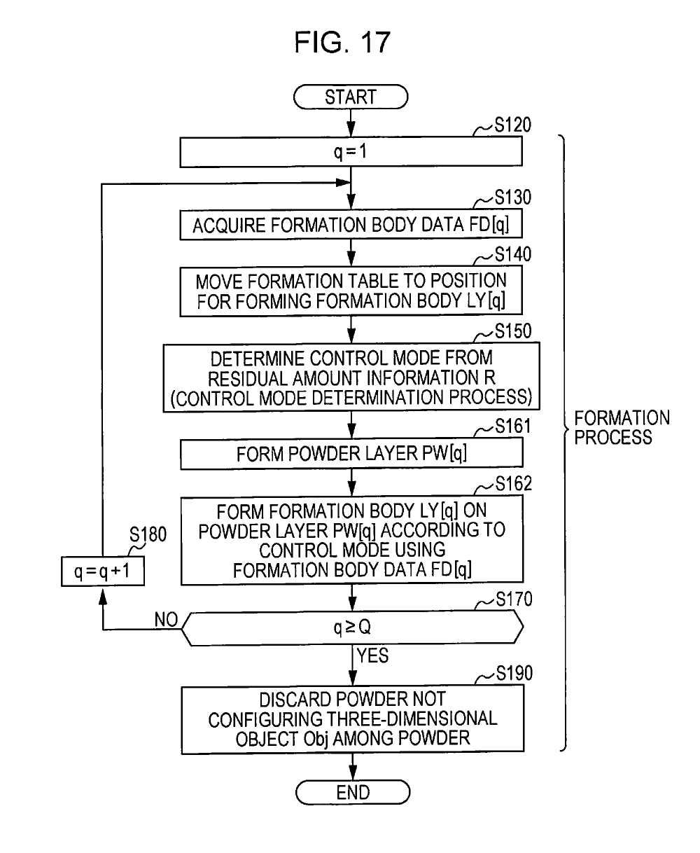

FIG. 17 is a flowchart showing an example of the operation of the three-dimensional object formation system 100 when executing the formation process according to the modification example. The formation process according to the modification example shown in FIG. 17 is the same as the formation process according to the embodiment shown in FIG. 10, except for executing the process shown in Steps S161 and S162 instead of Step S160 and executing the process shown in Step S190 when the determined result in Step S170 is positive.

As shown in FIG. 17, the control unit 6 according to the modification example controls the operation of each unit of the three-dimensional object formation apparatus 1 so that the powder layer formation unit forms the powder layer PW[q] (S161).

The control unit 6 according to the modification example controls the operation of each unit of the three-dimensional object formation apparatus 1 so as to form dots on the powder layer PW[q] to form the formation body LY[q] in the control mode determined in Step S150, using the formation body data FD[q] (S162). Specifically, first, in Step S162, the control unit 6 generates the waveform designation signal SI using the formation body data FD[q] and controls the operation of the head unit 3 so that the formation ink or the supporting ink is discharged to the powder layer PW[q] by the generated waveform designation signal SI in Step S162. Next, the control unit 6 controls the operation of the curing unit 61 so as to solidify the powder of a portion where the dots are formed on the powder layer PW[q], by curing the dots formed with the ink discharged to the powder layer PW[q]. Accordingly, the powder of the powder layer PW[q] is solidified with the ink and the formation body LY[q] can be formed.

The control unit 6 according to the modification example controls the operation of the powder discarding unit so as to discard the powder not configuring the three-dimensional object Obj after the three-dimensional object Obj is formed (S190).

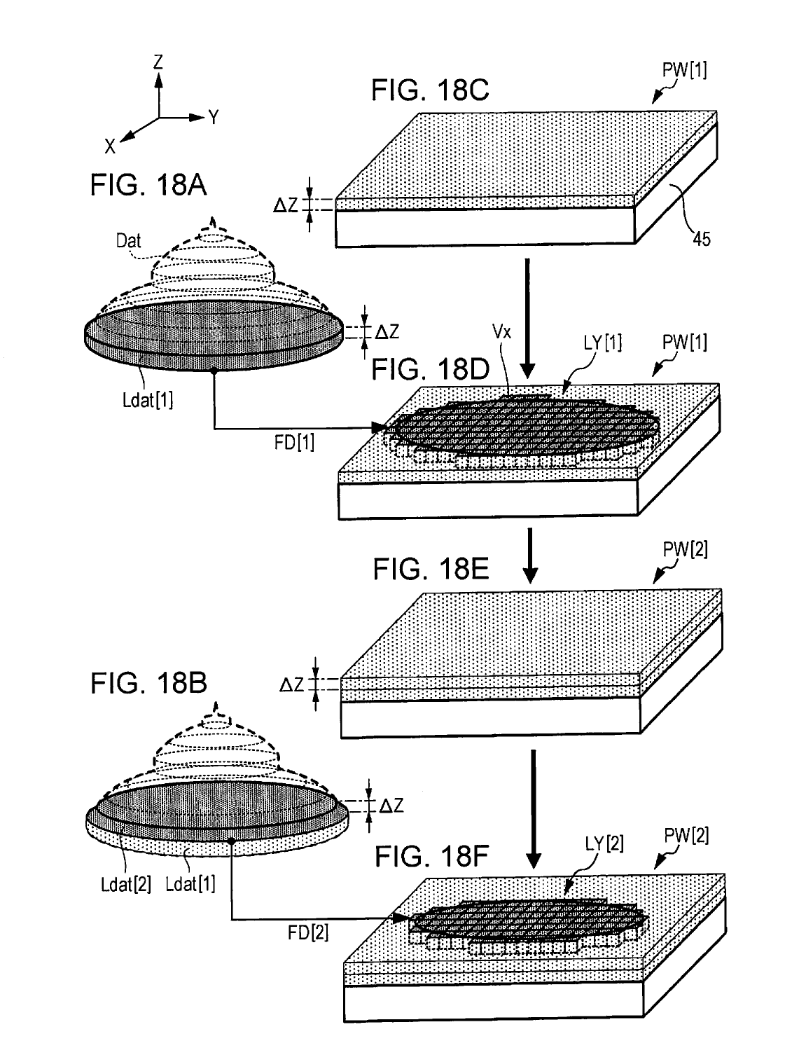

FIGS. 18A to 18F are explanatory diagrams for illustrating a relationship between the model data Dat and the section model data Ldat[q], the formation body data FD[q], the powder layer PW[q], and the formation body LY[q] according to the modification example.

Among these, FIGS. 18A and 18B show the section model data items Ldat[1] and Ldat[2] in the same manner as in FIGS. 2A and 2B. Even in the modification example, the section model data Ldat[q] is generated by slicing the model data Dat, the formation body data FD[q] is generated from the section model data Ldat[q], and the formation body LY[q] is formed with the dots formed based on the waveform designation signal SI generated using the formation body data FD[q]. Hereinafter, the formation of the formation body LY[q] according to the modification example will be described with reference to FIGS. 18C to 18F using the formation bodies LY-[1] and LY[2] as examples.

As shown in FIG. 18C, the control unit 6 controls the operation of the powder layer formation unit so as to form the powder layer PW[1] having the predetermined thickness ΔZ before forming the formation body LY[1] (see Step S161 described above).

Next, as shown in FIG. 18D, the control unit 6 controls the operation of each unit of the three-dimensional object formation apparatus 1 so that the formation body LY[1] is formed in the powder layer PW[1] (see Step S162 described above). Specifically, first, the control unit 6 controls the operation of the head unit 3 based on the waveform designation signal SI generated using the formation body data FD[1] to discharge the ink to the powder layer PW[1] to form the dots. Then, the control unit 6 controls the curing unit 61 so as to cure the dots formed on the powder layer PW[1] to solidify the powder in a portion where the dot is formed and form the formation body LY[1].

After that, as shown in FIG. 18E, the control unit 6 controls the powder layer formation unit so as to form the powder layer PW[2] having the predetermined thickness AZ on the powder layer PW[1] and the formation body LY[1]. As shown in FIG. 18F, the control unit 6 controls the operation of each unit of the three-dimensional object formation apparatus 1 so that the formation body LY[2] is formed.

As described above, the control unit 6 controls the execution of the lamination process of forming the formation body LY[q] in the powder layer PW[q] based on the waveform designation signal SI generated using the formation body data FD[q] and laminates the formation bodies LY[q] to form the three-dimensional object Obj and the support SP.

### Modification Example 7

In the embodiment described above, the ink discharged from the discharging unit D is a curable ink such as an ultraviolet curable ink, but the invention is not limited to the embodiment, and ink formed of a thermoplastic resin may be used.

In this case, it is preferable that the ink is discharged in a state of being heated in the discharging unit D. That is, the discharging unit D according to the modification example preferably performs a so-called thermal type discharging process of generating air bubbles in the cavity 320 to increase pressure in the cavity 320 by heating a heating element (not shown) provided in the cavity 320, to discharge the ink.

In this case, since the ink discharged from the discharging unit D is cooled and cured by the outside air, the three-dimensional object formation apparatus 1 may not include the curing unit 61.

### Modification Example 8

In the embodiment and the modification examples described above, the sizes of the dots which can be discharged by the three-dimensional object formation apparatus 1 are three of a small dot, a medium dot, and a large dot, but the invention is not limited to this embodiment, and the sizes of the dots which can be discharged by the three-dimensional object formation apparatus 1 may be one or more.

### Modification Example 9

In the embodiment and the modification examples described above, the formation data generation unit 93 is provided in the host computer 9, but the invention is not limited to this embodiment, and the formation data generation unit 93 may be provided in the three-dimensional object formation apparatus 1. For example, the formation data generation unit 93 may be mounted as a functional block which is realized by operation of the control unit 6 according to the control program.

When the three-dimensional object formation apparatus 1 includes the formation data generation unit 93, the three-dimensional object formation apparatus 1 can generate the formation body data FD based on the model data Dat supplied from the outside of the three-dimensional object formation apparatus 1 and form the three-dimensional object Obj based on the waveform designation signal SI generated using the formation body data FD.

### Modification Example 10

In the embodiment and the modification examples described above, the three-dimensional object formation system 100 includes the model data generation unit 92, but the invention is not limited to this embodiment, and the three-dimensional object formation system 100 may be configured without including the model data generation unit 92.

That is, the three-dimensional object formation system 100 may form the three-dimensional object Obj based on the model data Dat supplied from the outside of the three-dimensional object formation system 100.

### Modification Example 11

In the embodiment and the modification examples described above, the driving waveform signal Com is a signal including the waveforms PL1 to PL3, but the invention is not limited to this embodiment, and the driving waveform signal Com may be any signal, as long as it is a signal including a waveform at which the amounts of ink corresponding to at least one type of the size of the dot can be discharged from the discharging unit D. For example, the driving waveform signal Com may be set as a different waveform depending on the type of the ink.

In addition, in the embodiment and the modification examples described above, the bit number of the waveform designation signal SI[m] is two bits, but the invention is not limited to this embodiment, and the bit number of the waveform designation signal SI[m] may be suitably determined depending on the number of types of the sizes of the dots formed with the ink discharged from the discharging unit D.

What is claimed is:

1. A three-dimensional object formation apparatus comprising:
a head unit which discharges a plurality of types of liquid including first liquid for forming a support which supports a three-dimensional object and second liquid for forming the three-dimensional object, when forming the three-dimensional object, and forms dots with the discharged liquid;
a curing unit which cures the dots; and
a control unit which controls the head unit so as to form the support and form the three-dimensional object by laminating layered formation bodies formed with the cured dots,
wherein the control unit controls a plurality of control modes including a first control mode of controlling the head unit so that the first liquid is discharged from the head unit in order to form one dot, when designation data for designating the type of liquid for forming the dot designates the first liquid as liquid for forming the one dot configuring the support, and a second control mode of controlling the head unit so that the second liquid is discharged from the head unit in order to form the one dot, when the designation data designates the second liquid as liquid for forming the one dot.

2. A three-dimensional object formation apparatus comprising:
a head unit which discharges a plurality of types of liquid including first liquid for forming a support which supports a three-dimensional object and second liquid for forming the three-dimensional object, when forming the three-dimensional object, and forms dots with the discharged liquid;
a curing unit which cures the dots;
a control unit which controls the head unit so as to form the support and form the three-dimensional object by laminating layered formation bodies formed with the cured dots;
a storage unit which stores the first liquid; and
an output unit which outputs residual amount information showing a residual amount of the first liquid stored in the storage unit,
wherein the control unit controls a plurality of control modes including a first control mode of controlling the head unit so as to form the support with a plurality of dots formed of the first liquid, and a second control mode of controlling the head unit so as to form the support with a plurality of dots not including the dots formed of the first liquid and including the dots formed of the second liquid, and
the control mode is switched from the first control mode to the second control mode, when a residual amount of the first liquid shown by the residual amount information is changed from an amount greater than a first reference amount to an amount equal to or smaller than the first reference amount, when forming the three-dimensional object.

3. A three-dimensional object formation apparatus comprising:
a head unit which discharges a plurality of types of liquid including first liquid for forming a support which supports a three-dimensional object and second liquid for forming the three-dimensional object, when forming the three-dimensional object, and forms dots with the discharged liquid;
a curing unit which cures the dots;
a control unit which controls the head unit so as to form the support and form the three-dimensional object by laminating layered formation bodies formed with the cured dots;
a storage unit which stores the first liquid; and
an output unit which outputs residual amount information showing a residual amount of the first liquid stored in the storage unit,
wherein the control unit controls a plurality of control modes including a first control mode of controlling the head unit so as to form the support with a plurality of dots formed of the first liquid, and a third control mode of controlling the head unit so as to form the support with a plurality of dots including the dots formed of the first liquid and the dots formed of the second liquid, and
the control mode is switched from the first control mode to the third control mode, when a residual amount of the first liquid shown by the residual amount information is changed from an amount greater than a second reference amount to an amount equal to or smaller than the second reference amount, when forming the three-dimensional object.

4. The three-dimensional object formation apparatus according to claim 1,
wherein the second liquid is liquid of which a weight ratio of a color material component included in the second liquid is equal to or smaller than a predetermined value.

5. A control method of a three-dimensional object formation apparatus which includes a head unit which discharges a plurality of types of liquid including first liquid for forming a support which supports a three-dimensional object and second liquid for forming the three-dimensional object, when forming the three-dimensional object, and forms dots with the discharged liquid, and a curing unit which cures the dots, and forms the support and forms the three-dimensional object by laminating layered formation bodies formed with the cured dots, the method comprising:
controlling the head unit so that the support is formed in a plurality of control modes including a first control mode of discharging the first liquid from the head unit in order to form one dot, when designation data for designating the type of liquid for forming the dot designates the first liquid as liquid for forming the one dot configuring the support, and a second control mode of discharging the second liquid from the head unit in order to form the one dot, when the designation data designates the second liquid as liquid for forming the one dot.

6. A control program of a three-dimensional object formation apparatus which includes a head unit which discharges a plurality of types of liquid including first liquid for forming a support which supports a three-dimensional object and second liquid for forming the three-dimensional object, when forming the three-dimensional object, and forms dots with the discharged liquid, a curing unit which cures the dots, and a computer, and forms the support and forms the three-dimensional object by laminating layered formation bodies formed with the cured dots, the program causing the computer to function as:
a control unit which controls the head unit so that the support is formed in a plurality of control modes including a first control mode of controlling the head unit so that the first liquid is discharged from the head unit in order to form one dot, when designation data for designating the type of liquid for forming the dot designates the first liquid as liquid for forming the one dot configuring the support, and a second control mode of controlling the head unit so that the second liquid is discharged from the head unit in order to form the one dot, when the designation data designates the second liquid as liquid for forming the one dot.
